(19) United States
(12) Patent Application Publication
(10) Pub. No.: US 2026/0064714 A1
(43) Pub. Date: Mar. 5, 2026

(54) SYSTEM AND METHOD FOR PROVIDING AN OPEN DATA SHARE FOR DATA FORMATS WITH DELTA SHARING

(71) Applicant: ORACLE INTERNATIONAL CORPORATION, Redwood Shores, CA (US)

(72) Inventors: Xiaoyu Yao, Seattle, WA (US); Sharad Singh, Noida (IN); Bharat Viswanadham, Langley (CA); Shashikant Banerjee, Bengaluru (IN); Vivek Chaudhary, Bengaluru (IN)

(21) Appl. No.: 19/310,323

(22) Filed: Aug. 26, 2025

Related U.S. Application Data
(60) Provisional application No. 63/690,596, filed on Sep. 4, 2024.

(51) Int. Cl. G06F 16/25

(52) U.S. Cl. CPC G06F 16/258

(57) ABSTRACT

Embodiments described herein are generally related to cloud computing, cloud infrastructure, or data analytics environments, and are particularly directed to systems and methods for use with a data analytics environment or other cloud computing environment to provide an open data share for data formats with Delta Sharing. The systems and methods described herein allow for a data sharing service to share data to a client regardless of the format of the data. In accordance with an embodiment, a data share server generates a data log associated with a data table at data source. The data share server can receive a request from a data sharing client. Based upon the created data log associated with the data source, the data share server can share the data table, together with the generated data log associated therewith, to the data sharing client.

### CLAIM OF PRIORITY AND CROSS-REFERENCE TO RELATED APPLICATIONS

This application claims the benefit of priority to U.S. Provisional Patent Application titled “SYSTEM AND METHOD FOR USE WITH A DATA ANALYTICS ENVIRONMENT TO PROVIDE AN OPEN DATA SHARE FOR DATA FORMATS WITH DELTA SHARING”, Application No. 63/690,596, filed Sep. 4, 2024; which above application and the contents thereof are herein incorporated by reference.

### COPYRIGHT NOTICE

A portion of the disclosure of this patent document contains material which is subject to copyright protection. The copyright owner has no objection to the facsimile reproduction by anyone of the patent document or the patent disclosure, as it appears in the Patent and Trademark Office patent file or records, but otherwise reserves all copyright rights whatsoever.

### TECHNICAL FIELD

Embodiments described herein are generally related to cloud computing, cloud infrastructure, or data analytics environments, and are particularly directed to systems and methods for use with a data analytics environment to provide an open data share for data formats with Delta Sharing.

### BACKGROUND

Generally described, data analytics enables the computer-based examination of an amount of data, to derive an analytic data, metrics, conclusions, or other types of analytical information from, or descriptive of, the source data. Systems and methods can be used, for example, to generate an analytic business intelligence data, such as a set of data metrics or measures operating as key performance indicators, which analytically describe an organization's business-related data in a format useful to its decision-makers.

In environments such as cloud computing, cloud infrastructure, or data analytics environments, the sharing of data is of notable importance as enterprise organizations seek ways to securely and efficiently exchange or transfer data with their customers and other authorized users. For example, a retailer may want to share their sales data with suppliers in real time, and a supplier may want to share their real-time inventory information with a retailer.

Data sharing protocols, such as the Delta Sharing protocol, enable a secure real-time exchange of datasets, which can facilitate secure data sharing across software environments, and provide users with the ability to directly connect to the shared data through, for example, Pandas, or other systems that implement the data sharing protocol.

Some implementations of a Delta Sharing protocol allow data providers to securely share data to consumers/partners across different cloud platforms and languages, using a limited variety of data formats, for example, Parquet and Delta formats.

However, there are many other available customer data formats, such as, for example, .csv, Apache Avro, Apache ORC, or JSON, that are widely used in modern data analytics, but are not supported by the typical Delta Sharing protocols. This means that customers who use these data formats for their business data cannot use the typical Delta Sharing protocols without expensive data copy/conversion, which also incurs the potential loss of source of truth when a copy of a data source is generated and converted.

### SUMMARY

Embodiments described herein are generally related to cloud computing, cloud infrastructure, or data analytics environments, and are particularly directed to systems and methods for use with a data analytics environment or other cloud computing environment to provide an open data share for data formats with Delta Sharing. The systems and methods described herein allow for a data sharing service to share data to a client regardless of the format of the data.

In accordance with an embodiment, the method for use with a cloud computing, cloud infrastructure, or data analytics environment, to provide an open data share for data formats with Delta Sharing, comprises providing, by a computer including one or more processors, access to a cloud computing, cloud infrastructure, or data analytics environment. A data share server, provided in association with the cloud computing, cloud infrastructure, or data analytics environment, generates a data log associated with a data table at data source. The data share server can receive a request from a data sharing client. Based upon the created data log associated with the data source, the data share server can share the data table, together with the generated data log associated therewith, to the data sharing client.

### BRIEF DESCRIPTION OF THE DRAWINGS

FIG. 1 illustrates a system for providing a cloud computing, cloud infrastructure, or data analytics environment, in accordance with an embodiment.

FIG. 2 illustrates a system for providing a cloud computing, cloud infrastructure, or data analytics environment, in accordance with an embodiment.

FIG. 3 illustrates an example cloud infrastructure architecture, in accordance with an embodiment.

FIG. 4 illustrates an example cloud infrastructure architecture, in accordance with an embodiment.

FIG. 5 illustrates an example cloud infrastructure architecture, in accordance with an embodiment.

FIG. 6 illustrates an example cloud infrastructure architecture, in accordance with an embodiment.

FIG. 7 illustrates an example use of the system to provide a data analytics environment, in accordance with an embodiment.

FIG. 8 further illustrates an example data analytics environment, in accordance with an embodiment.

FIG. 9 further illustrates an example data analytics environment, in accordance with an embodiment.

FIG. 10 further illustrates an example data analytics environment, in accordance with an embodiment.

FIG. 11 further illustrates an example data analytics environment, in accordance with an embodiment.

FIG. 12 further illustrates an example data analytics environment, in accordance with an embodiment.

FIG. 13 illustrates a system for use with a data analytics environment to provide an open data share for data formats with Delta Sharing, in accordance with an embodiment.

FIG. 14 illustrates a system for use with a data analytics environment to provide an open data share for data formats with Delta Sharing, in accordance with an embodiment.

FIG. 15 illustrates an exemplary file format for use with a data analytics environment to provide an open data share for data formats with Delta Sharing, in accordance with an embodiment.

FIG. 16 illustrates an exemplary file format for use with a data analytics environment to provide an open data share for data formats with Delta Sharing, in accordance with an embodiment.

FIG. 17 illustrates a screenshot produced by a system for use with a data analytics environment to provide an open data share for data formats with Delta Sharing, in accordance with an embodiment.

FIG. 18 illustrates a screenshot produced by a system for use with a data analytics environment to provide an open data share for data formats with Delta Sharing, in accordance with an embodiment.

FIG. 19 illustrates a screenshot produced by a system for use with a data analytics environment to provide an open data share for data formats with Delta Sharing, in accordance with an embodiment.

FIG. 20 is a flowchart of a method for use with a data analytics environment to provide an open data share for data formats with Delta Sharing, in accordance with an embodiment.

### DETAILED DESCRIPTION

Generally described, data analytics enables the computer-based examination of an amount of data, to derive an analytic data, metrics, conclusions, or other types of analytical information from, or descriptive of, the source data. Systems and methods can be used, for example, to generate an analytic business intelligence data, such as a set of data metrics or measures operating as key performance indicators, which analytically describe an organization's business-related data in a format useful to its decision-makers.

In environments such as cloud computing, cloud infrastructure, or data analytics environments, the sharing of data is of notable importance as enterprise organizations seek ways to securely and efficiently exchange or transfer data with their customers and other authorized users. For example, a retailer may want to share their sales data with suppliers in real time, and a supplier may want to share their real-time inventory information with a retailer.

Data sharing protocols, such as the Delta Sharing protocol, enable a secure real-time exchange of datasets, which can facilitate secure data sharing across software environments, and provide users with the ability to directly connect to the shared data through, for example, Pandas, or other systems that implement the data sharing protocol.

Some implementations of a Delta Sharing protocol allow data providers to securely share data to consumers/partners across different cloud platforms and languages, using a limited variety of data formats, for example, Parquet and Delta formats.

However, there are many other available customer data formats, such as, for example, .csv, Apache Avro, Apache ORC, or JSON, that are widely used in modern data analytics, but are not supported by the typical Delta Sharing protocols. This means that customers who use these data formats for their business data cannot use the typical Delta Sharing protocols without expensive data copy/conversion, which also incurs the potential loss of source of truth when a copy of a data source is generated and converted.

To address this, embodiments described herein are generally related to cloud computing, cloud infrastructure, or data analytics environments, and are particularly directed to systems and methods for use with a data analytics environment or other cloud computing environment to provide an open data share for data formats with Delta Sharing. The systems and methods described herein allow for a data sharing service to share data to a client regardless of the format of the data.

In accordance with an embodiment, the method for use with a cloud computing, cloud infrastructure, or data analytics environment, to provide an open data share for data formats with Delta Sharing, comprises providing, by a computer including one or more processors, access to a cloud computing, cloud infrastructure, or data analytics environment. A data share server, provided in association with the cloud computing, cloud infrastructure, or data analytics environment, generates a data log associated with a data table at data source. The data share server can receive a request from a data sharing client. Based upon the created data log associated with the data source, the data share server can share the data table, together with the generated data log associated therewith, to the data sharing client.

### Cloud Infrastructure Environments

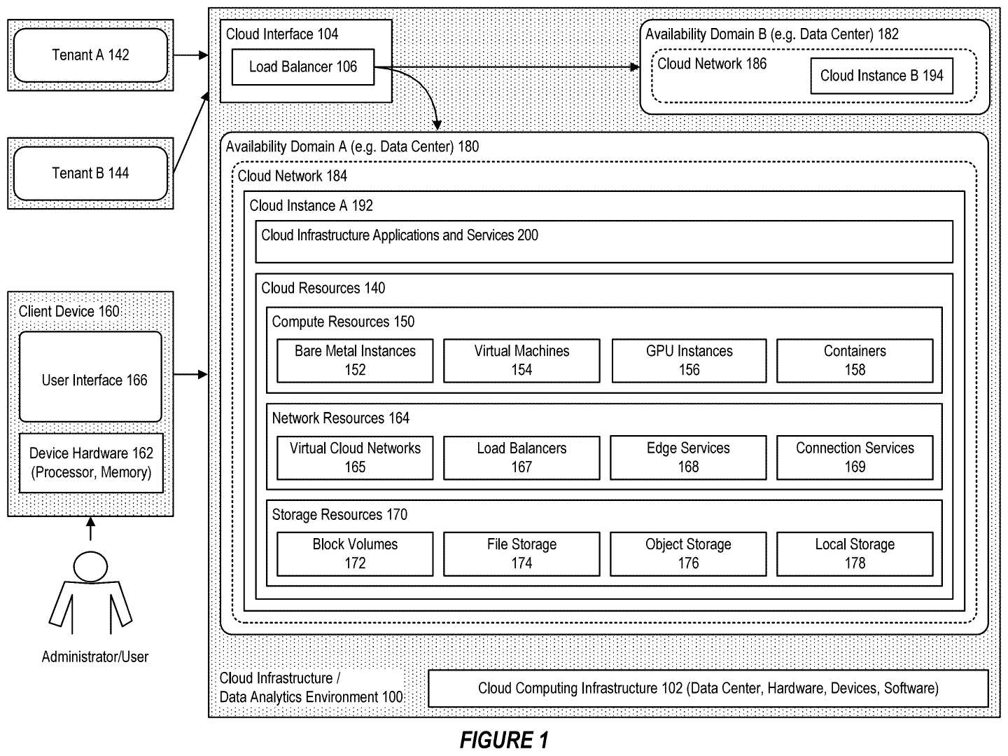

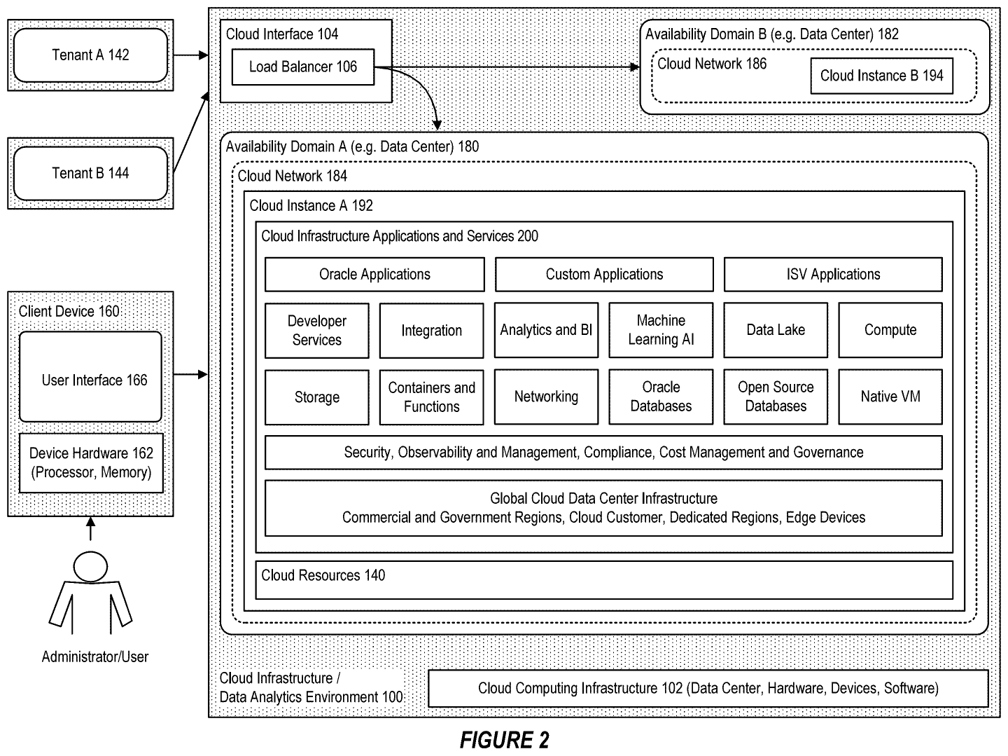

FIGS. 1-2 illustrate a system for providing a cloud computing, cloud infrastructure, or data analytics environment, in accordance with an embodiment.

In accordance with an embodiment, the components and processes illustrated in FIG. 1, and as further described herein with regard to various embodiments, can be provided as software or program code executable by a computer system or other type of processing device, for example a cloud computing system.

The illustrated example is provided for purposes of illustrating a computing environment which can be used to provide dedicated or private label cloud environments, for use by tenants of a cloud infrastructure in accessing subscription-based software products, services, or other offerings associated with the cloud infrastructure environment. In accordance with other embodiments, the various components, processes, and features described herein can be used with other types of cloud computing environments.

As illustrated in FIG. 1, in accordance with an embodiment, a cloud computing, cloud infrastructure, or data analytics environment 100 can operate on a cloud computing infrastructure 102 comprising hardware (e.g., processor, memory), software resources, and one or more cloud interfaces 104 or other application program interfaces (API) that provide access to the shared cloud resources via one or more load balancers 106.

In accordance with an embodiment, the cloud infrastructure environment supports the use of availability domains, such as, for example, availability domains A 180, B 182, which enables customers to create and access cloud networks 184, 186, and run cloud instances A 192, B 194.

In accordance with an embodiment, a tenancy can be created for each cloud tenant/customer, for example tenant A 142, B 144, which provides a secure and isolated partition within the cloud infrastructure environment within which the customer can create, organize, and administer their cloud resources. A cloud tenant/customer can access an availability domain and a cloud network to access each of their cloud instances.

In accordance with an embodiment, a client device, such as, for example, a computing device 160 having a device hardware 162 (e.g., processor, memory), and graphical user interface 166, can enable an administrator other user to communicate with the cloud infrastructure environment via a network such as, for example, a wide area network, local area network, or the Internet, to create or update cloud services.

In accordance with an embodiment, the cloud infrastructure environment provides access to shared cloud resources 140 via, for example, a compute resources layer 150, a network resources layer 164, and/or a storage resources layer 170. Customers can launch cloud instances as needed, to meet compute and application requirements. After a customer provisions and launches a cloud instance, the provisioned cloud instance can be accessed from, for example, a client device.

In accordance with an embodiment, the compute resources layer can comprise resources, such as, for example, bare metal cloud instances 152, virtual machines 154, graphical processing unit (GPU) compute cloud instances 156, and/or containers 158. The compute resources layer can be used to, for example, provision and manage bare metal compute cloud instances, or provision cloud instances as needed to deploy and run applications, as in an on-premises data center.

For example, in accordance with an embodiment, the cloud infrastructure environment can provide control of physical host (bare metal) machines within the compute resources layer, which run as compute cloud instances directly on bare metal servers, without a hypervisor.

In accordance with an embodiment, the cloud infrastructure environment can also provide control of virtual machines within the compute resources layer, which can be launched, for example, from an image, wherein the types and quantities of resources available to a virtual machine cloud instance can be determined, for example, based upon the image that the virtual machine was launched from.

In accordance with an embodiment, the network resources layer can comprise a number of network-related resources, such as, for example, virtual cloud networks (VCNs) 165, load balancers 167, edge services 168, and/or connection services 169.

In accordance with an embodiment, the storage resources layer can comprise a number of resources, such as, for example, data/block volumes 172, file storage 174, object storage 176, and/or local storage 178.

In accordance with an embodiment, the cloud environment can include a container orchestration system, and container orchestration system API, that enables containerized application workflows to be deployed to a container orchestration environment, for example a Kubernetes (k8s) cluster.

For example, in accordance with an embodiment, the cloud environment can be used to provide containerized compute cloud instances within the compute resources layer, and a container orchestration implementation (e.g., Oracle Cloud Infrastructure Container Engine for Kubernetes (OKE)), can be used to build and launch containerized applications or cloud-native applications, specify compute resources that the containerized application requires, and provision the required compute resources.

As illustrated in FIG. 2, in accordance with an embodiment, the cloud infrastructure or data analytics environment can include a range of complementary cloud-based components, for example as cloud infrastructure applications and services 200, that enable organizations or enterprise customers to operate their applications and services in a highly-available hosted environment.

By way of example, in accordance with an embodiment, a self-contained cloud region can be provided as a complete, e.g., Oracle Cloud Infrastructure (OCI) dedicated region within an organization's data center that offers the data center operator the agility, scalability, and economics of a public cloud, while retaining full control of their data and applications to meet security, regulatory, or data residency requirements.

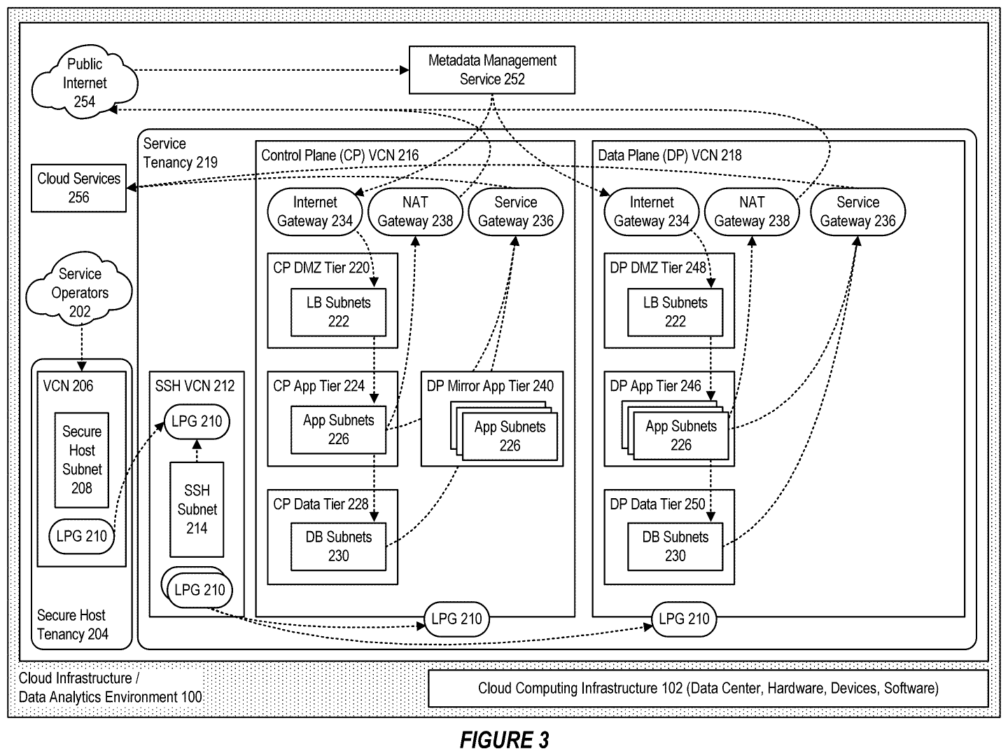

FIGS. 3-6 illustrate an example cloud infrastructure architecture, in accordance with an embodiment.

As illustrated in FIG. 3, in accordance with an embodiment, service operators 202 can be communicatively coupled to a secure host tenancy 204 that can include a virtual cloud network (VCN) 206 and a secure host subnet 208.

In some examples, the service operators may be using one or more client computing devices, which may be portable handheld devices (e.g., a telephone, a computing tablet, a personal digital assistant (PDA)) or wearable devices (e.g., a head mounted display), running software such as Microsoft Windows, and/or a variety of mobile operating systems such as iOS, Android, and the like, and being Internet, e-mail, short message service (SMS), or other communication protocol enabled. Alternatively, the client computing devices can be general purpose personal computers including, by way of example, personal computers and/or laptop computers running various versions of Microsoft Windows®, Apple Macintosh®, and/or Linux operating systems. The client computing devices can be workstation computers running any of a variety of commercially-available UNIX® or UNIX-like operating systems, including without limitation the variety of GNU/Linux operating systems, such as for example, Chrome. Alternatively, or in addition, client computing devices may be any other electronic device, such as a thin-client computer, an Internet-enabled gaming system (e.g., a Microsoft Xbox gaming console), and/or a personal messaging device, capable of communicating over a network that can access the VCN and/or the Internet.

In accordance with an embodiment, a VCN can include a local peering gateway (LPG) 210 that can be communicatively coupled to a secure shell (SSH) VCN 212 via an LPG contained in the SSH VCN. The SSH VCN can include an SSH subnet 214, and the SSH VCN can be communicatively coupled to a control plane VCN 216 via the LPG contained in the control plane VCN. Also, the SSH VCN can be communicatively coupled to a data plane VCN 218 via an LPG. The control plane VCN and the data plane VCN can be contained in a service tenancy 219 that can be owned and/or operated by the cloud infrastructure provider.

In accordance with an embodiment, a control plane VCN can include a control plane demilitarized zone (DMZ) tier 220 that acts as a perimeter network (e.g., portions of a corporate network between the corporate intranet and external networks). The DMZ-based servers may have restricted responsibilities that help contain potential breaches. Additionally, the DMZ tier can include one or more load balancer (LB) subnet(s) 222, a control plane app tier 224 that can include app subnet(s) 226, and a control plane data tier 228 that can include database (DB) subnet(s) 230 (e.g., frontend DB subnet(s) and/or backend DB subnet(s)). The LB subnet(s) contained in the control plane DMZ tier can be communicatively coupled to the app subnet(s) contained in the control plane app tier, and an Internet gateway 234 that can be contained in the control plane VCN, and the app subnet(s) can be communicatively coupled to the DB subnet(s) contained in the control plane data tier and a service gateway 236 and a network address translation (NAT) gateway 238. The control plane VCN can include the service gateway and the NAT gateway.

In accordance with an embodiment, the control plane VCN can include a data plane mirror app tier 240 that can include app subnet(s). The app subnet(s) contained in the data plane mirror app tier can include a virtual network interface controller (VNIC) that can execute a compute instance. The compute instance can communicatively couple the app subnet(s) of the data plane mirror app tier to app subnet(s) that can be contained in a data plane app tier.

In accordance with an embodiment, the data plane VCN can include the data plane app tier 246, a data plane DMZ tier 248, and a data plane data tier 250. The data plane DMZ tier can include LB subnet(s) that can be communicatively coupled to the app subnet(s) of the data plane app tier and the Internet gateway of the data plane VCN. The app subnet(s) can be communicatively coupled to the service gateway of the data plane VCN and the NAT gateway of the data plane VCN. The data plane data tier can also include the DB subnet(s) that can be communicatively coupled to the app subnet(s) of the data plane app tier.

In accordance with an embodiment, the Internet gateway of the control plane VCN and of the data plane VCN can be communicatively coupled to a metadata management service 252 that can be communicatively coupled to the public Internet 254. The public Internet can be communicatively coupled to the NAT gateway of the control plane VCN and of the data plane VCN. The service gateway of the control plane VCN and of the data plane VCN can be communicatively coupled to cloud services 256.

In accordance with an embodiment, the service gateway of the control plane VCN, or of the data plane VCN, can make application programming interface (API) calls to cloud services without going through the public Internet. The API calls to cloud services from the service gateway can be one-way: the service gateway can make API calls to cloud services, and cloud services can send requested data to the service gateway. Generally, cloud services may not initiate API calls to the service gateway.

In accordance with an embodiment, the secure host tenancy can be directly connected to the service tenancy, which may be otherwise isolated. The secure host subnet can communicate with the SSH subnet through an LPG that may enable two-way communication over an otherwise isolated system. Connecting the secure host subnet to the SSH subnet may give the secure host subnet access to other entities within the service tenancy.

In accordance with an embodiment, the control plane VCN may allow users of the service tenancy to set up or otherwise provision desired resources. Desired resources provisioned in the control plane VCN may be deployed or otherwise used in the data plane VCN. In some examples, the control plane VCN can be isolated from the data plane VCN, and the data plane mirror app tier of the control plane VCN can communicate with the data plane app tier of the data plane VCN via VNICs that can be contained in the data plane mirror app tier and the data plane app tier.

In accordance with an embodiment, users of the system, or customers, can make requests, for example create, read, update, or delete (CRUD) operations, through the public Internet that can communicate the requests to the metadata management service. The metadata management service can communicate the request to the control plane VCN through the Internet gateway. The request can be received by the LB subnet(s) contained in the control plane DMZ tier. The LB subnet(s) may determine that the request is valid, and in response to this determination, the LB subnet(s) can transmit the request to app subnet(s) contained in the control plane app tier. If the request is validated and requires a call to the public Internet, the call to the Internet may be transmitted to the NAT gateway that can make the call to the Internet. Metadata to be stored by the request can be stored in the DB subnet(s).

In accordance with an embodiment, the data plane mirror app tier can facilitate direct communication between the control plane VCN and the data plane VCN. For example, changes, updates, or other suitable modifications to configuration may be desired to be applied to the resources contained in the data plane VCN. By means of a VNIC, the control plane VCN can directly communicate with, and can thereby execute the changes, updates, or other suitable modifications to configuration to, resources contained in the data plane VCN.

In accordance with an embodiment, the control plane VCN and the data plane VCN can be contained in the service tenancy. In this case, the user, or the customer, of the system may not own or operate either the control plane VCN or the data plane VCN. Instead, the cloud infrastructure provider may own or operate the control plane VCN and the data plane VCN, both of which may be contained in the service tenancy. This embodiment can enable isolation of networks that may prevent users or customers from interacting with the resources of other users or other customers. Also, this embodiment may allow users or customers of the system to store databases privately without needing to rely on the public Internet for storage, which may not provide a desired level of threat prevention.

In accordance with an embodiment, the LB subnet(s) contained in the control plane VCN can be configured to receive a signal from the service gateway. In this embodiment, the control plane VCN and the data plane VCN may be configured to be called by a customer of the cloud infrastructure provider without calling the public Internet. Customers of the cloud infrastructure provider may desire this embodiment since the database(s) that the customers use may be controlled by the cloud infrastructure provider and may be stored on the service tenancy, which may be isolated from the public Internet.

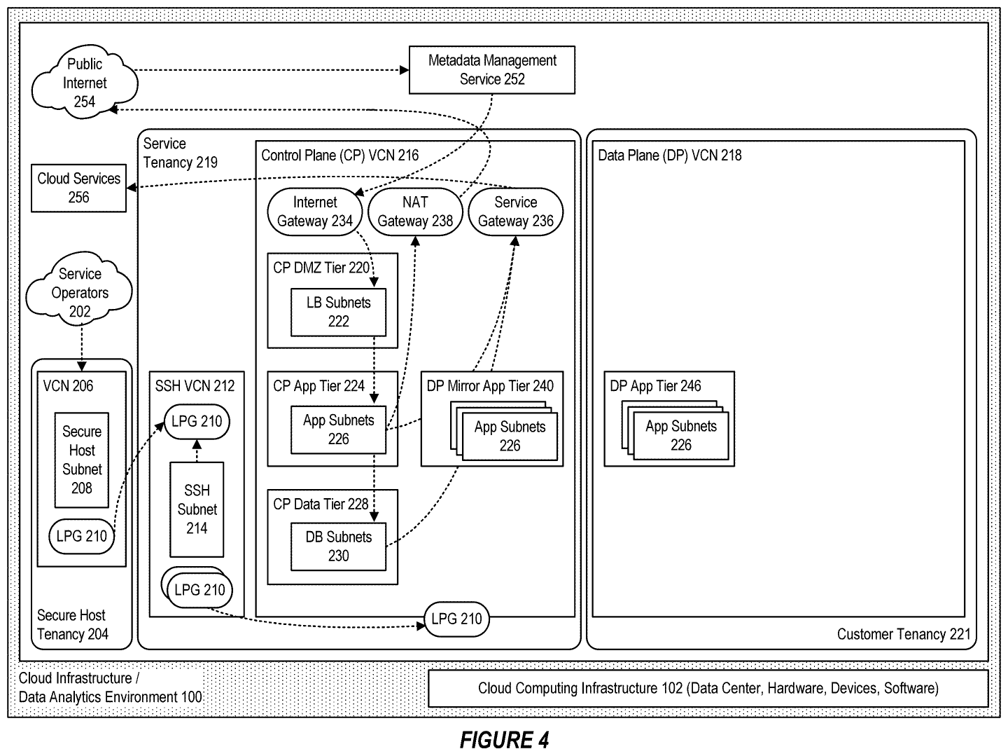

As illustrated in FIG. 4, in accordance with an embodiment, the data plane VCN can be contained in the customer tenancy 221. In this case, the cloud infrastructure provider may provide the control plane VCN for each customer, and the cloud infrastructure provider may, for each customer, set up a unique compute instance that is contained in the service tenancy. Each compute instance may allow communication between the control plane VCN, contained in the service tenancy, and the data plane VCN that is contained in the customer tenancy. The compute instance may allow resources that are provisioned in the control plane VCN that is contained in the service tenancy, to be deployed or otherwise used in the data plane VCN that is contained in the customer tenancy.

In accordance with an embodiment, a customer of the cloud infrastructure provider may have databases that are managed and operate within the customer tenancy. In this example, the control plane VCN can include the data plane mirror app tier that can include app subnet(s). The data plane mirror app tier can reside in the data plane VCN, but the data plane mirror app tier may not be provided in the data plane VCN. That is, the data plane mirror app tier may have access to the customer tenancy, but the data plane mirror app tier may not exist in the data plane VCN or be owned or operated by the customer. The data plane mirror app tier may be configured to make calls to the data plane VCN, but may not be configured to make calls to any entity contained in the control plane VCN. The customer may desire to deploy or otherwise use resources in the data plane VCN that are provisioned in the control plane VCN, and the data plane mirror app tier can facilitate the desired deployment, or other usage of resources, of the customer.

In accordance with an embodiment, a customer of the cloud infrastructure provider can apply filters to the data plane VCN. In this embodiment, the customer can determine what the data plane VCN can access, and the customer may restrict access to the public Internet from the data plane VCN. The cloud infrastructure provider may not be able to apply filters or otherwise control access of the data plane VCN to any outside networks or databases. Applying filters and controls by the customer onto the data plane VCN, contained in the customer tenancy, can help isolate the data plane VCN from other customers and from the public Internet.

In accordance with an embodiment, cloud services can be called by the service gateway to access services that may not exist on the public Internet, on the control plane VCN, or on the data plane VCN. The connection between cloud services and the control plane VCN or the data plane VCN may not be continuous. Cloud services may exist on a different network owned or operated by the cloud infrastructure provider. Cloud services may be configured to receive calls from the service gateway and may be configured to not receive calls from the public Internet. Some cloud services may be isolated from other cloud services, and the control plane VCN may be isolated from cloud services that may not be in the same region as the control plane VCN.

For example, in accordance with an embodiment, the control plane VCN may be located in a “Region 1,” and a cloud service “Deployment 1,” may be located in Region 1 and in “Region 2.” If a call to Deployment 1 is made by the service gateway contained in the control plane VCN located in Region 1, the call may be transmitted to Deployment 1 in Region 1. In this example, the control plane VCN, or Deployment 1 in Region 1, may not be communicatively coupled to, or otherwise in communication with Deployment 1 in Region 2.

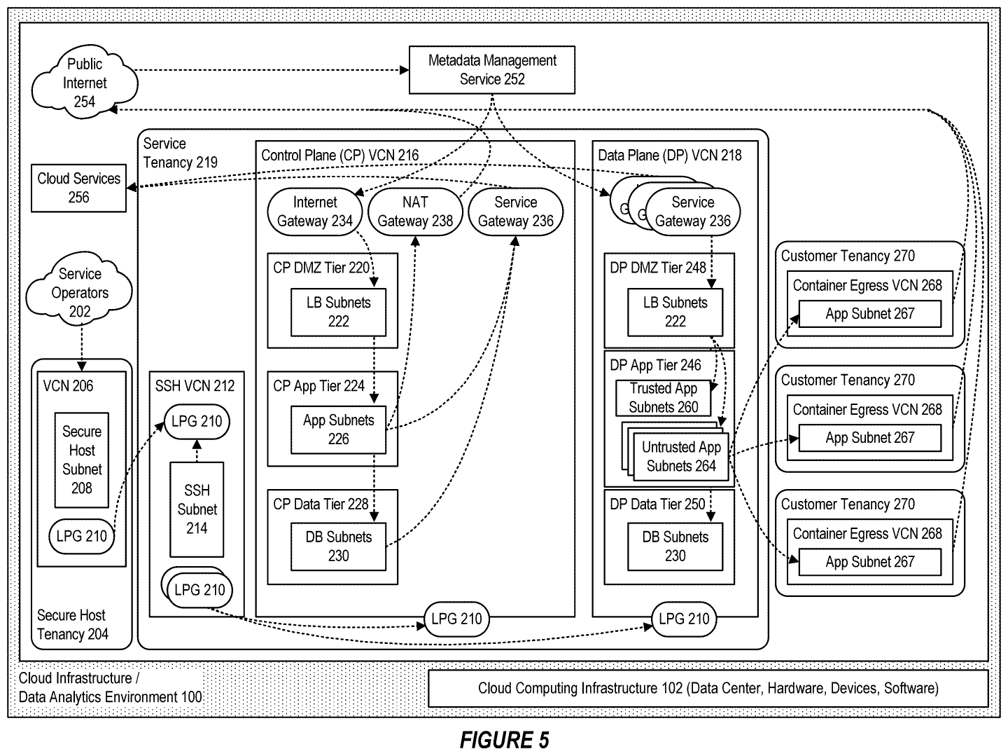

As illustrated in FIG. 5, in accordance with an embodiment, the trusted app subnet(s) 260 can be communicatively coupled to the service gateway contained in the data plane VCN, the NAT gateway contained in the data plane VCN, and DB subnet(s) contained in the data plane data tier. The untrusted app subnet(s) 264 can be communicatively coupled to the service gateway contained in the data plane VCN and DB subnet(s) contained in the data plane data tier. The data plane data tier can include DB subnet(s) that can be communicatively coupled to the service gateway contained in the data plane VCN.

In accordance with an embodiment, untrusted app subnet(s) can include one or more primary VNICs (1)-(N) that can be communicatively coupled to tenant virtual machines (VMs). Each tenant VM can be communicatively coupled to a respective app subnet 267 (1)-(N) that can be contained in respective container egress VCNs 268 (1)-(N) that can be contained in respective customer tenancies 270 (1)-(N). Respective secondary VNICs can facilitate communication between the untrusted app subnet(s) contained in the data plane VCN and the app subnet contained in the container egress VCN. Each container egress VCN can include a NAT gateway that can be communicatively coupled to the public Internet.

In accordance with an embodiment, the public Internet can be communicatively coupled to the NAT gateway contained in the control plane VCN and contained in the data plane VCN. The service gateway contained in the control plane VCN and contained in the data plane VCN can be communicatively coupled to cloud services.

In accordance with an embodiment, the data plane VCN can be integrated with customer tenancies. This integration can be useful or desirable for customers of the cloud infrastructure provider in cases that may require additional support when executing code. For example, the customer may provide code to run that may be potentially destructive, may communicate with other customer resources, or may otherwise cause undesirable effects.

In accordance with an embodiment, a customer of the cloud infrastructure provider may grant temporary network access to the cloud infrastructure provider and request a function to be attached to the data plane app tier. Code to run the function may be executed in the VMs, and may not be configured to run anywhere else on the data plane VCN. Each VM may be connected to one customer tenancy. Respective containers (1)-(N) contained in the VMs may be configured to run the code. In this case, there can be a dual isolation (e.g., the containers running code, where the containers may be contained in at least the VM that are contained in the untrusted app subnet(s)), which may help prevent incorrect or otherwise undesirable code from damaging the network of the cloud infrastructure provider or from damaging a network of a different customer. The containers may be communicatively coupled to the customer tenancy and may be configured to transmit or receive data from the customer tenancy. The containers may not be configured to transmit or receive data from any other entity in the data plane VCN. Upon completion of running the code, the cloud infrastructure provider may dispose of the containers.

In accordance with an embodiment, the trusted app subnet(s) may run code that may be owned or operated by the cloud infrastructure provider. In this embodiment, the trusted app subnet(s) may be communicatively coupled to the DB subnet(s) and be configured to execute CRUD operations in the DB subnet(s). The untrusted app subnet(s) may be communicatively coupled to the DB subnet(s), and configured to execute read operations in the DB subnet(s). The containers that can be contained in the VM of each customer and that may run code from the customer may not be communicatively coupled with the DB subnet(s).

In accordance with an embodiment, the control plane VCN and the data plane VCN may not be directly communicatively coupled; or there may be no direct communication between the control plane VCN and the data plane VCN. However, communication can occur indirectly, wherein an LPG may be established by the cloud infrastructure provider that can facilitate communication between the control plane VCN and the data plane VCN. In another example, the control plane VCN or the data plane VCN can make a call to cloud services via the service gateway. For example, a call to cloud services from the control plane VCN can include a request for a service that can communicate with the data plane VCN.

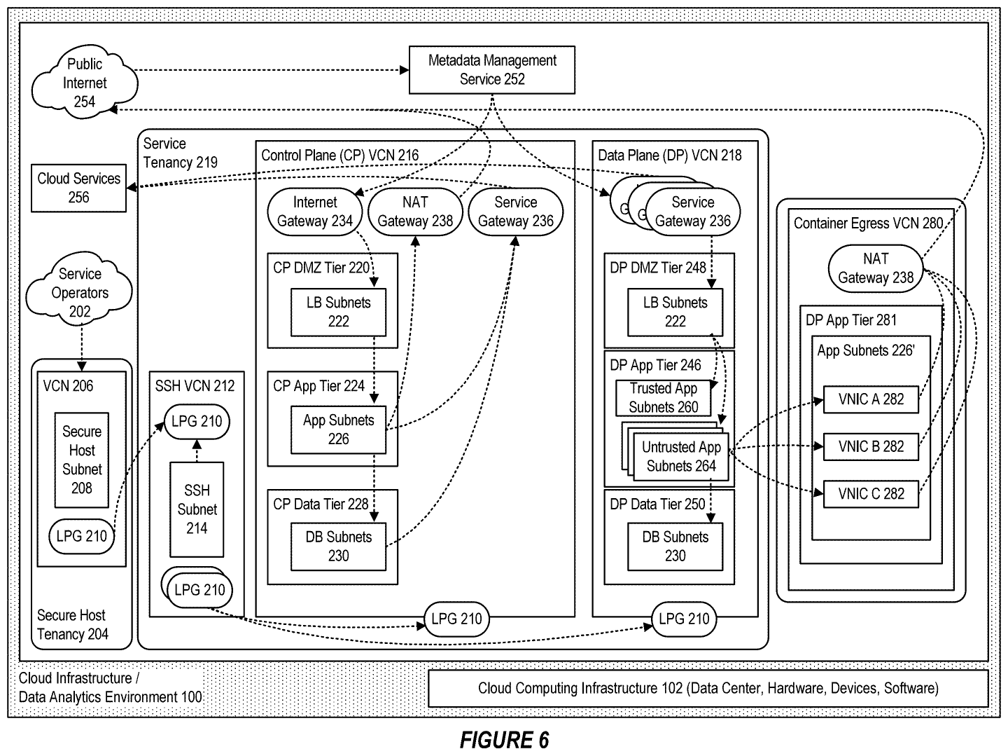

As illustrated in FIG. 6, in accordance with an embodiment, the trusted app subnet(s) can be communicatively coupled to the service gateway contained in the data plane VCN, the NAT gateway contained in the data plane VCN, and DB subnet(s) contained in the data plane data tier. The untrusted app subnet(s) can be communicatively coupled to the service gateway contained in the data plane VCN and DB subnet(s) contained in the data plane data tier. The data plane data tier can include DB subnet(s) that can be communicatively coupled to the service gateway contained in the data plane VCN.

In accordance with an embodiment, untrusted app subnet(s) can include primary VNICs that can be communicatively coupled to tenant virtual machines (VMs) residing within the untrusted app subnet(s). Each tenant VM can run code in a respective container, and be communicatively coupled to an app subnet that can be contained in a data plane app tier 281 that can be contained in a container egress VCN 280. Respective secondary VNICs 282 (1)-(N) can facilitate communication between the untrusted app subnet(s) contained in the data plane VCN and the app subnet contained in the container egress VCN. The container egress VCN can include a NAT gateway that can be communicatively coupled to the public Internet.

In accordance with an embodiment, the Internet gateway contained in the control plane VCN and contained in the data plane VCN can be communicatively coupled to a metadata management service that can be communicatively coupled to the public Internet. The public Internet can be communicatively coupled to the NAT gateway contained in the control plane VCN and contained in the data plane VCN. The service gateway contained in the control plane VCN and contained in the data plane VCN can be communicatively coupled to cloud services.

In accordance with an embodiment, the pattern illustrated in FIG. 6 may be considered an exception to the pattern illustrated in FIG. 5 and may be desirable for a customer if the cloud infrastructure provider cannot directly communicate with the customer (e.g., a disconnected region). The respective containers that are contained in the VMs for each customer can be accessed in real-time by the customer. The containers may be configured to make calls to respective secondary VNICs contained in app subnet(s) of the data plane app tier that can be contained in the container egress VCN. The secondary VNICs can transmit the calls to the NAT gateway that may transmit the calls to the public Internet. In this example, the containers that can be accessed in real-time by the customer can be isolated from the control plane VCN and can be isolated from other entities contained in the data plane VCN. The containers may also be isolated from resources from other customers.

In other examples, the customer can use the containers to call cloud services. In this example, the customer may run code in the containers that requests a service from cloud services. The containers can transmit this request to the secondary VNICs that can transmit the request to the NAT gateway that can transmit the request to the public Internet. The public Internet can be used to transmit the request to LB subnet(s) contained in the control plane VCN via the Internet gateway. In response to determining the request is valid, the LB subnet(s) can transmit the request to app subnet(s) that can transmit the request to cloud services via the service gateway.

It should be appreciated that IaaS architectures depicted in the above figures may have other components than those depicted. Further, the embodiments shown in the figures are only some examples of a cloud infrastructure system that may incorporate an embodiment of the disclosure. In some other embodiments, the IaaS systems may have more or fewer components than shown in the figures, may combine two or more components, or may have a different configuration or arrangement of components.

In certain embodiments, the IaaS systems described herein may include a suite of applications, middleware, and database service offerings that are delivered to a customer in a self-service, subscription-based, elastically scalable, reliable, highly available, and secure manner.

### Data Analytics Environments

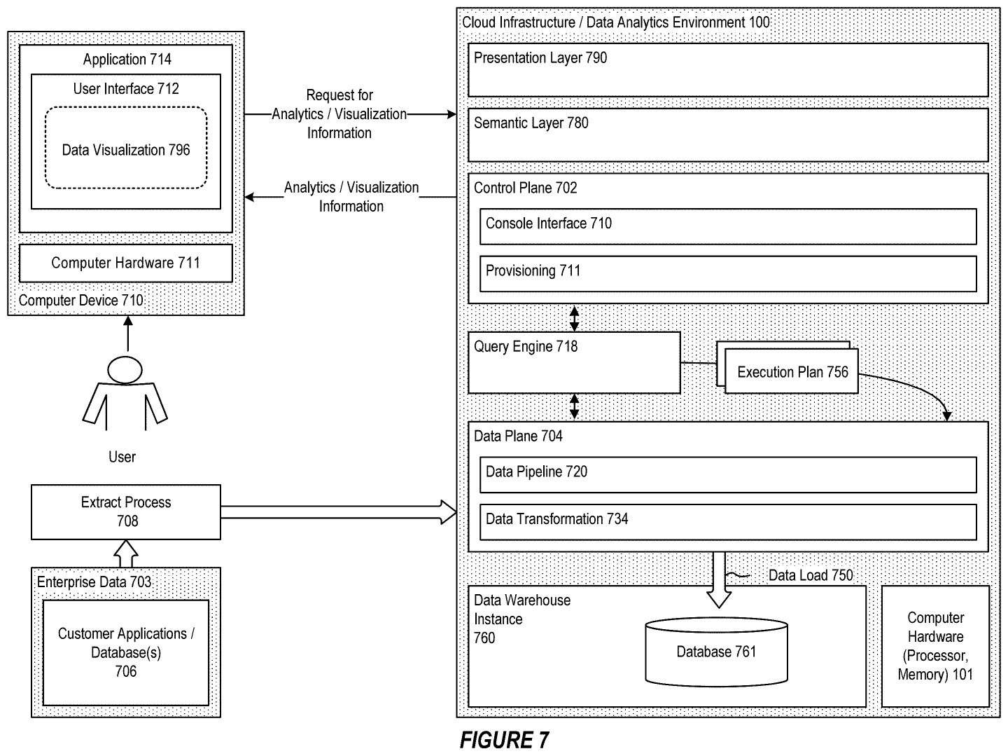

FIG. 7 illustrates an example use of the system to provide a data analytics environment, in accordance with an embodiment.

The example embodiment illustrated in FIG. 7 is provided for purposes of illustrating an example of a data analytics environment in association with which various embodiments described herein can be used. In accordance with other embodiments and examples, the approach described herein can be used with other types of data analytics, database, or data warehouse environments.

As illustrated in FIG. 7, in accordance with an embodiment, a data analytics environment 100 can be provided by, or otherwise operate at, a computer system having a computer hardware (e.g., processor, memory) 101, and including one or more software components operating as a control plane 702, and a data plane 704, and providing access in the manner of a data layer to a data warehouse instance 760 (e.g., having a database 761, or other type of data source).

In accordance with an embodiment, the control plane operates to provide control for cloud or other software products offered within the context of a cloud environment. For example, in accordance with an embodiment, the control plane can include a console interface 710 that enables access by a customer (tenant) and/or a cloud environment having a provisioning component 711, for example to allow customers to provision services for use within their enterprise environment. The provisioning component can provision a data warehouse instance, including a customer schema of the data warehouse; and populate the data warehouse instance with the appropriate information supplied by the customer.

In accordance with an embodiment, the data plane can include a data pipeline or process layer 720 and a data transformation layer 734, that together process data from an organization's enterprise software environment, and load a transformed data into the data warehouse. The data transformation layer can include a data model, such as, for example, a knowledge model (KM), or other type of data model, that the system uses to transform the data received from business applications and corresponding databases, into a model format understood by the data analytics environment. The data plane is responsible for performing extract, transform, and load (ETL) operations, including extracting data from an organization's enterprise software environment, transforming the extracted data into a model format, and loading the transformed data into a customer schema of the data warehouse.

For example, in accordance with an embodiment, each customer (tenant) of the environment can be associated with their own customer schema; and can be additionally provided with read-only access to the data analytics schema, which can be updated by a data pipeline or process, for example, an ETL process, on a periodic or other basis. For example, a data pipeline or process can be scheduled to execute at intervals (e.g., hourly/daily/weekly) to extract enterprise data 703 from an enterprise software environment, such as, for example, business productivity software applications and corresponding databases 706.

In accordance with an embodiment, an extract process 708 can extract the data, whereupon extraction the data pipeline or process can insert extracted data into a data staging area, which can act as a temporary staging area for the extracted data. When the extract process has completed its extraction, the data transformation layer can be used to transform the extracted data into a model format to be loaded into the customer schema of the data warehouse. During the data transformation, the system can perform dimension generation, fact generation, and aggregate generation, as appropriate. Dimension generation can include generating dimensions or fields for loading into the data warehouse instance.

In accordance with an embodiment, after transformation of the extracted data, the data pipeline or process can execute a warehouse load procedure 750, to load the transformed data into the customer schema of the data warehouse instance. Subsequent to the loading of the transformed data into customer schema, the transformed data can be analyzed and used in a variety of additional business intelligence processes.

Different customers may have different requirements with regard to how their data is classified, aggregated, or transformed, for providing data analytics or business intelligence data, or developing software analytic applications. In accordance with an embodiment, to support such different requirements, a semantic layer 980 can include data defining a semantic model of a customer's data; which is useful in assisting users in understanding and accessing that data using commonly-understood business terms; and provide custom content to a presentation layer 190.

In accordance with an embodiment, a customer may perform modifications to their data source model, to support their particular requirements, for example by adding custom facts or dimensions associated with the data stored in their data warehouse instance; and the system can extend the semantic model accordingly. A semantic model can be defined, for example, in an Oracle environment, as a BI Repository (RPD) file, having metadata that defines logical schemas, physical schemas, physical-to-logical mappings, aggregate table navigation, and/or other constructs that implement the various physical layer, business model and mapping layer, and presentation layer aspects of the semantic model.

In accordance with an embodiment, the presentation layer can enable access to the data content using, for example, a software analytic application, user interface, analytics dashboard, key performance indicators (KPI's); or other type of report or interface as may be provided by products such as, for example, Oracle Analytics Cloud, or Oracle Analytics for Applications.

In accordance with an embodiment, a query engine 718 (e.g., an Oracle Business Intelligence Server, OBIS instance) operates in the manner of a federated query engine to serve analytical queries or requests from clients directed to data stored at a database. The query engine can push down operations to supported databases, in accordance with a query execution plan 956, wherein a logical query can include Structured Query Language (SQL) statements received from the clients; while a physical query includes database-specific statements that the query engine sends to the database to retrieve data when processing the logical query.

In accordance with an embodiment, a user/developer can interact with a client computer device 710 that includes a computer hardware 711 (e.g., processor, storage, memory), user interface 712, and client application 714. A query engine or business intelligence server generally operates to process inbound, e.g., SQL, requests against a database model, build and execute one or more physical database queries, process the data appropriately, and return the data in response to the request.

To accomplish this, in accordance with an embodiment, the query engine can include a logical or business model, or metadata, that describes the data available as subject areas for queries; a request generator that takes incoming queries and turns them into physical queries for use with a connected data source; and a navigator that takes the incoming query, navigates the logical model and generates those physical queries that best return the data required for a particular query.

For example, in accordance with an embodiment, the query engine may employ a logical model mapped to data in a data warehouse, by creating a simplified star schema business model over various data sources so that the user can query data as if it originated at a single source. The information can then be returned to the presentation layer as subject areas, according to business model layer mapping rules.

In accordance with an embodiment, the query engine can process queries against a database according to a query execution plan. During operation the query engine can create a query execution plan which can then be further optimized, for example to perform aggregations of data necessary to respond to a request. Data can be combined together and further calculations applied, before the results are returned to the calling application.

In accordance with an embodiment, a request for data analytics or visualization information can be received via a client application and user interface as described above, and communicated to the data analytics environment (in the example of a cloud environment, via a cloud service). The system can retrieve an appropriate dataset to address the user/business context, for use in generating and returning the requested data analytics or visualization information to the client, as a data visualization 796.

In accordance with an embodiment, a client application can be implemented as software or computer-readable program code executable by a computer system or processing device, and having a user interface, such as, for example, a software application user interface or a web browser interface. The client application can retrieve or access data via an Internet/HTTP or other type of network connection to the data analytics environment, or in the example of a cloud environment via a cloud service provided by the environment.

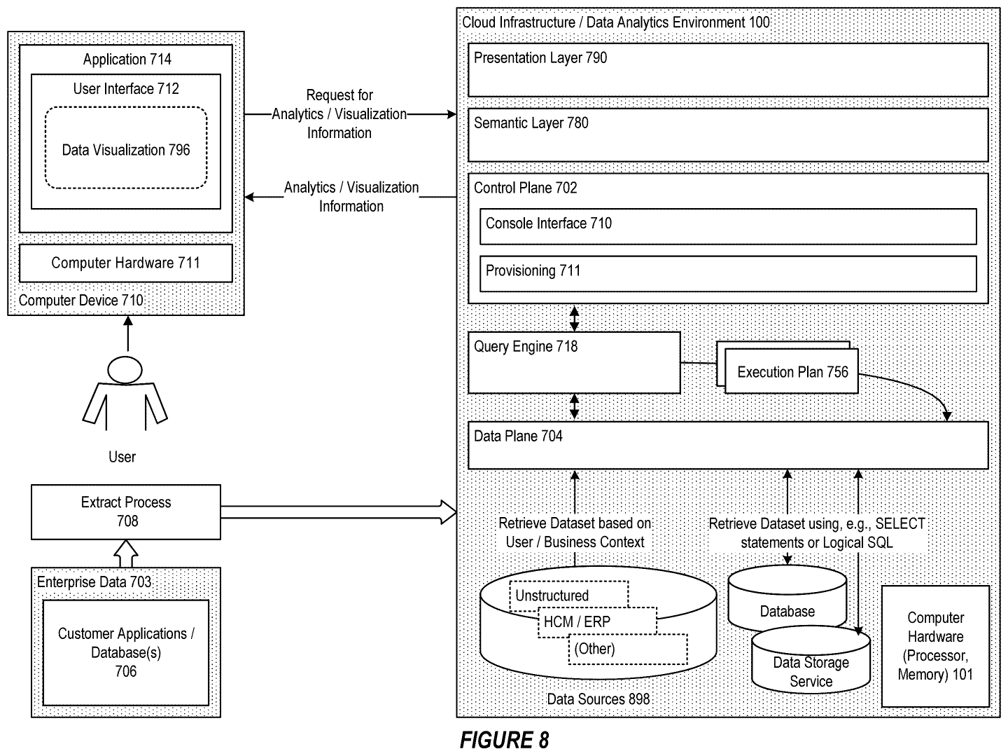

FIG. 8 further illustrates an example data analytics environment, in accordance with an embodiment.

As illustrated in FIG. 8, in accordance with an embodiment, the data analytics environment enables a dataset to be retrieved, received, or prepared from one or more data source(s) 898, for example via one or more data source connections. Examples of the types of data that can be transformed, analyzed, or visualized using the systems and methods described herein include data directed to Enterprise Resource Planning (ERP), Human Capital Management (HCM), or Human Resources (HR), or other types of data provided at one or more of a database, data storage service, or other type of data repository or data source.

For example, in accordance with an embodiment, a request for data analytics or visualization information can be received via a client application and user interface as described above, and communicated to the data analytics environment, for example via a cloud service. The system can retrieve an appropriate dataset to address the user/business context, for use in generating and returning the requested data analytics or visualization information to the client.

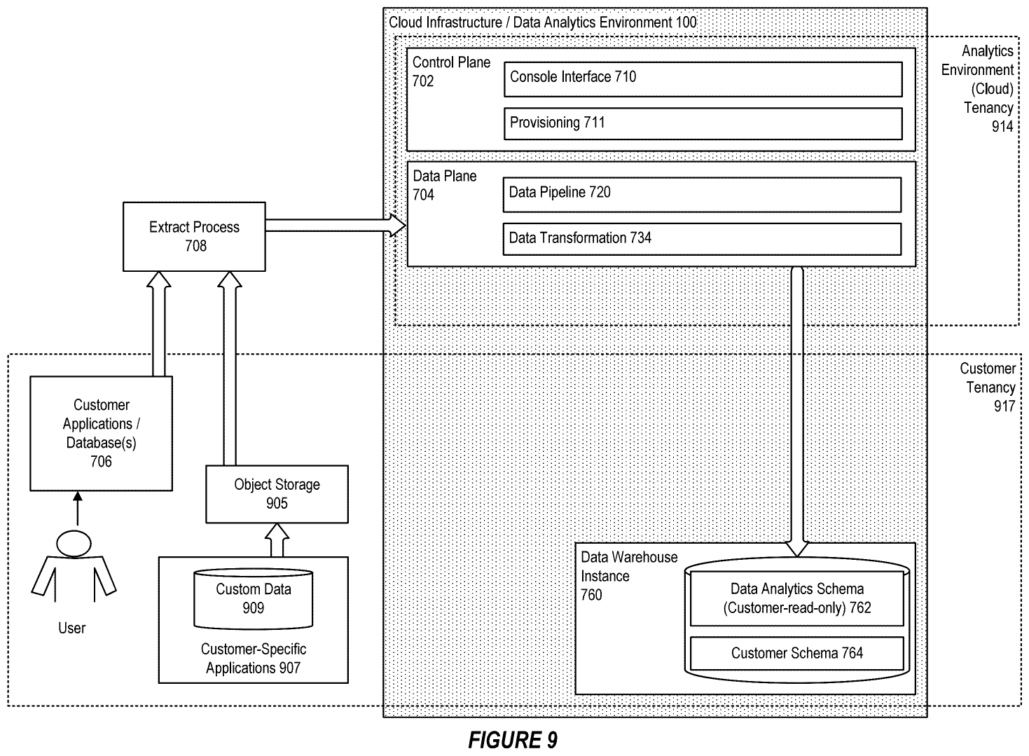

FIG. 9 further illustrates an example data analytics environment, in accordance with an embodiment.

As illustrated in FIG. 9, in accordance with an embodiment, data can be sourced, e.g., from a customer's (tenant's) enterprise software environment (706), using the data pipeline process; or as custom data 909 sourced from one or more customer-specific applications 907; and loaded to a data warehouse instance, including in some examples the use of an object storage 905 for storage of the data. A user can create a dataset that uses tables from different connections and schemas. The system uses the relationships defined between these tables to create relationships or joins in the dataset.

In accordance with an embodiment, the data warehouse can include a default data analytics schema 762 and, for each customer (tenant) of the system, a customer schema 764. For each customer (tenant), the system uses the data analytics schema that is maintained and updated by the system, within a system/cloud tenancy 914, to pre-populate a data warehouse instance for the customer, based on an analysis of the data within that customer's enterprise applications environment, and within a customer tenancy 917. As such, the data analytics schema maintained by the system enables data to be retrieved, by the data pipeline or process, from the customer's environment, and loaded to the customer's data warehouse instance.

In accordance with an embodiment, the system also provides, for each customer of the environment, a customer schema that allows the customer to supplement and utilize the data within their own data warehouse instance. For each customer, their resultant data warehouse instance operates as a database whose contents are partly-controlled by the customer; and partly-controlled by the environment (system).

For example, in accordance with an embodiment, a data warehouse can include a data analytics schema and, for each customer/tenant, a customer schema sourced from their enterprise software environment. The data provisioned in a data warehouse tenancy is accessible only to that tenant; while at the same time allowing access to various, e.g., ETL-related or other features of the shared environment.

In accordance with an embodiment, for a particular customer/tenant, upon extraction of their data, the data pipeline or process can insert the extracted data into a data staging area for the tenant, which can act as a temporary staging area for the extracted data. When the extract process has completed its extraction, the data transformation layer can be used to transform the extracted data into a model format to be loaded into the customer schema of the data warehouse.

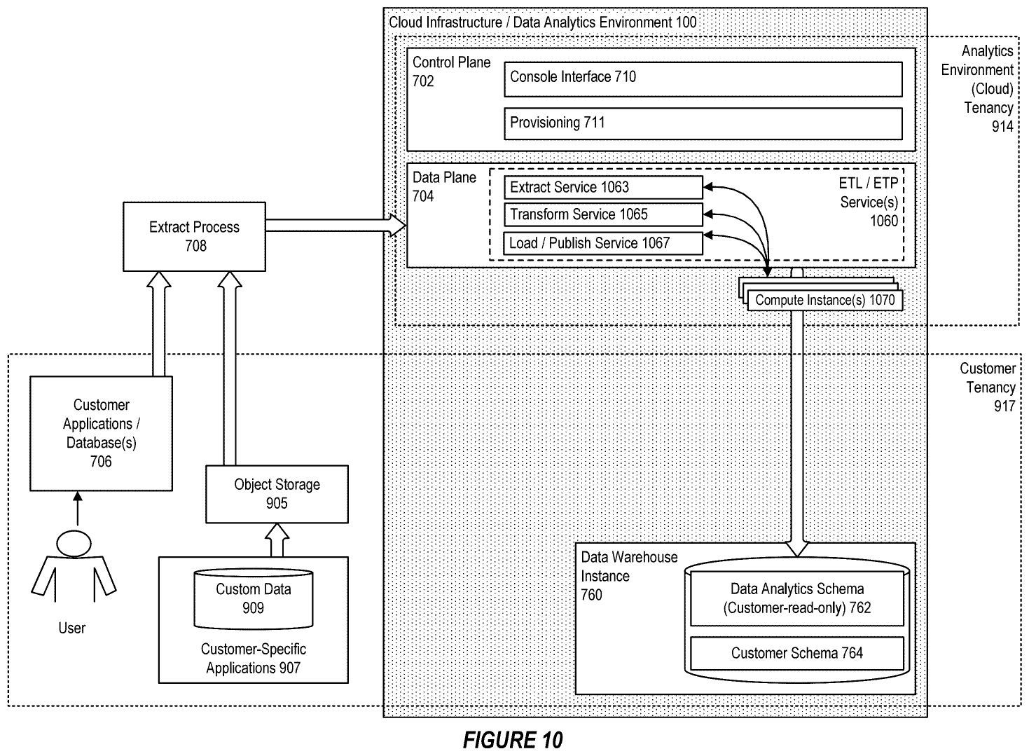

FIG. 10 further illustrates an example data analytics environment, in accordance with an embodiment.

As illustrated in FIG. 10, in accordance with an embodiment, the process of extracting data from a customer's (tenant's) enterprise software environment, and loading the data to a data warehouse instance, or refreshing the data in a data warehouse, generally involves several stages, performed by an ETP service 1060 or process, including one or more extraction service 1063; transformation service 1065; and load/publish service 1067, executed by one or more compute instance(s) 1070.

For example, in accordance with an embodiment, extracted files can be uploaded to an object storage component for storage of the data. The transformation process then applies a business logic while loading them to a target data warehouse, e.g., an Autonomous Data Warehouse (ADW) database, which is internal to the data pipeline or process, and is not exposed to the customer (tenant). A load/publish service or process takes the data from the ADW database and publishes it to a data warehouse instance that is accessible to the customer (tenant).

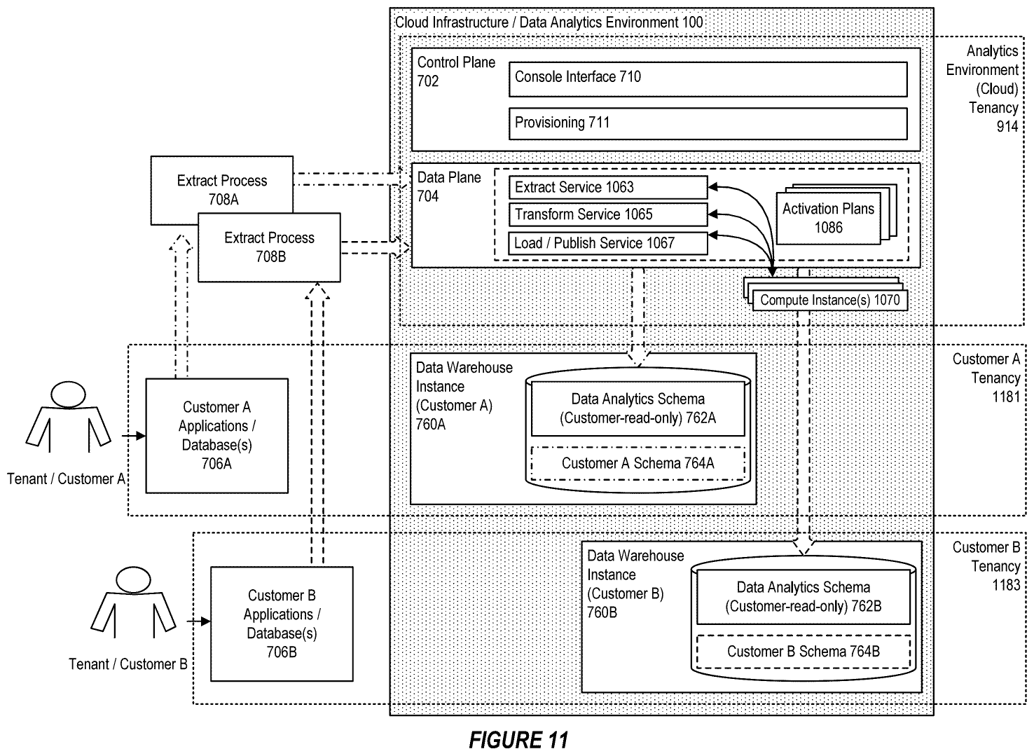

FIG. 11 further illustrates an example data analytics environment, in accordance with an embodiment.

As illustrated in FIG. 11, in accordance with an embodiment, the data pipeline or process maintains, for each of a plurality of customers (tenants), for example customer A, customer B, a data analytics schema that is updated on a periodic basis, by the system in accordance with best practices for a particular analytics use case. For each of a plurality of customers (e.g., customers A, B), the system uses the data analytics schema 762A, 762B, that is maintained and updated by the system, to pre-populate a data warehouse instance for the customer, based on an analysis of the data within that customer's enterprise applications environment 706A, 706B, and within each customer's tenancy (e.g., customer A tenancy 1181, customer B tenancy 1183); so that data is retrieved, by the data pipeline or process, from the customer's environment, and loaded to the customer's data warehouse instance 760A, 760B.

In accordance with an embodiment, the data analytics environment also provides, for each of a plurality of customers of the environment, a customer schema (e.g., customer A schema 764A, customer B schema 764B) that allows the customer to supplement and utilize the data within their own data warehouse instance.

As described above, in accordance with an embodiment, for each of a plurality of customers of the data analytics environment, their resultant data warehouse instance operates as a database whose contents are partly-controlled by the customer; and partly-controlled by the data analytics environment (system); including that their database appears pre-populated with appropriate data that has been retrieved from their enterprise applications environment to address various analytics use cases. When the extract process 708A, 708B for a particular customer has completed its extraction, the data transformation layer can be used to transform the extracted data into a model format to be loaded into the customer schema of the data warehouse.

In accordance with an embodiment, activation plans 1086 can be used to control the operation of the data pipeline or process services for a customer, for a particular functional area, to address that customer's (tenant's) particular needs. For example, an activation plan can define a number of extract, transform, and load (publish) services or steps to be run in a certain order, at a certain time of day, and within a certain window of time.

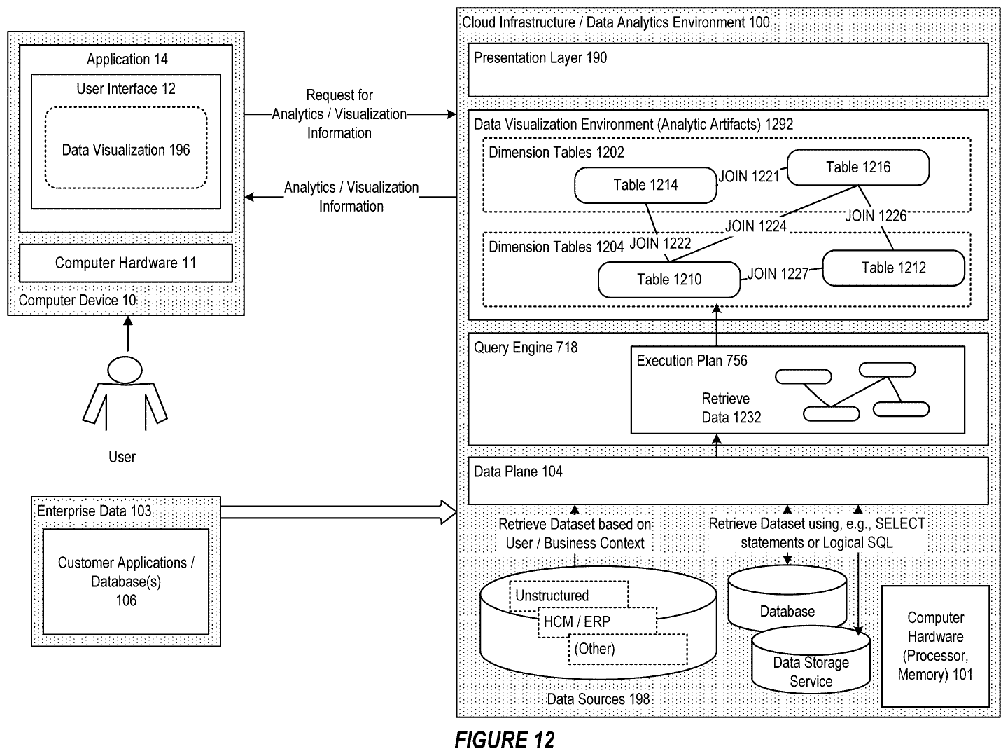

FIG. 12 further illustrates an example data analytics environment, in accordance with an embodiment.

Generally described, within a database or data warehouse, the data of interest may be spread across multiple tables. In such environments, joins can be used to stitch the data from various tables together, to better prepare the data for analysis.

For example, as illustrated in FIG. 12, in accordance with an embodiment, the data analytics environment enables a dataset to be retrieved, received, or prepared from one or more data source(s), for example via one or more data source connections, fact and/or dimension tables 1210, 1212, 1214, 1216, or joins 1221, 1222, 1224, 1226, 1227 between selections of dimension tables 1202, 1204.

In accordance with an embodiment, a request received at a data visualization environment to display analytic artifacts 1292, for example as may be related to key performance indicators, analytics dashboards, or scorecards, can be received via a client application and user interface as described above, and communicated to the data analytics environment via a cloud service. The system can retrieve 1232 an appropriate dataset using, e.g., SELECT statements, to address the user/business context, for use in generating and returning the requested data analytics or visualization information to the client.

Open Data Share for Data Formats with Delta Sharing

In environments such as cloud computing, cloud infrastructure, or data analytics environments, the sharing of data is of notable importance as enterprise organizations seek ways to securely and efficiently exchange or transfer data with their customers and other authorized users. For example, a retailer may want to share their sales data with suppliers in real time, and a supplier may want to share their real-time inventory information with a retailer.

Data sharing protocols, such as the Delta Sharing protocol, enable a secure real-time exchange of datasets, which can facilitate secure data sharing across software environments, and provide users with the ability to directly connect to the shared data through, for example, Pandas, or other systems that implement the data sharing protocol.

Some implementations of a Delta Sharing protocol allow data providers to securely share data to consumers/partners across different cloud platforms and languages, using a limited variety of data formats, for example, Parquet and Delta formats.

However, there are many other available customer data formats, such as, for example, .csv, Apache Avro, Apache ORC, or JSON, that are widely used in modern data analytics, but are not supported by the typical Delta Sharing protocols. This means that customers who use these data formats for their business data cannot use the typical Delta Sharing protocols without expensive data copy/conversion, which also incurs the potential loss of source of truth when a copy of a data source is generated and converted.

To address this, embodiments described herein are generally related to cloud computing, cloud infrastructure, or data analytics environments, and are particularly directed to systems and methods for use with a data analytics environment or other cloud computing environment to provide an open data share for data formats with Delta Sharing. The systems and methods described herein allow for a data sharing service to share data to a client regardless of the format of the data.

In accordance with an embodiment, the method for use with a cloud computing, cloud infrastructure, or data analytics environment, to provide an open data share for data formats with Delta Sharing, comprises providing, by a computer including one or more processors, access to a cloud computing, cloud infrastructure, or data analytics environment. A data share server, provided in association with the cloud computing, cloud infrastructure, or data analytics environment, generates a data log associated with a data table at data source. The data share server can receive a request from a data sharing client. Based upon the created data log associated with the data source, the data share server can share the data table, together with the generated data log associated therewith, to the data sharing client.

In accordance with an embodiment, the described approach makes data sharing protocols, such as the Delta Sharing protocol, open and format-agnostic, expanding the use of Delta Sharing with additional data formats, to provide a truly open protocol to share data. A customer can share any data format, from any source, to any cloud environment or other data recipient, using an open protocol with zero data movement or copy. This represents an improvement over existing solutions, which are largely built based on additional data copy, which is not advisable in modern data lake best practice.

For example, currently, Delta Sharing customers have to convert their Avro, ORC, or JSON formats to a Delta format before they can securely share the data out. The conversion introduces additional data copy and consistency issues. Unlike alternative approaches that solely work on Delta format, the described approach provides an in-house alternative that can support secure data sharing for all data formats without the need of making a copy of the data. The described approach not only saves the compute and storage cost of data conversion and data copy, but also eases the management of data share with a single source of truth in the data storage, such as a data lake.

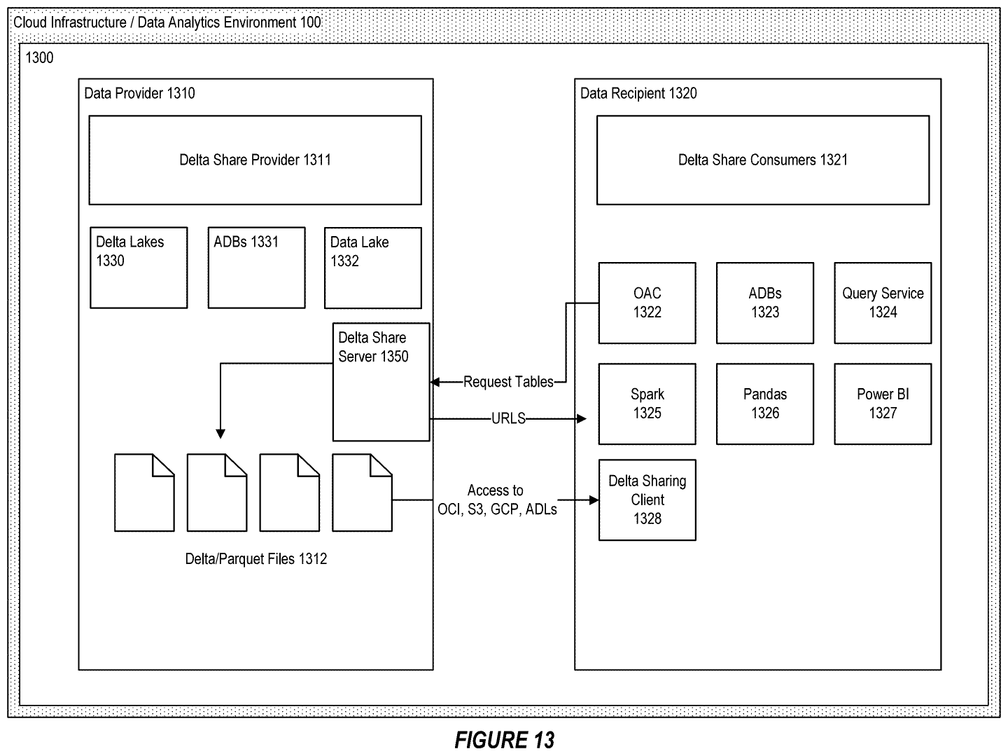

FIG. 13 illustrates a system for use with a data analytics environment to provide an open data share for data formats with Delta Sharing, in accordance with an embodiment.

In accordance with an embodiment, at a cloud computing, cloud infrastructure or data analytics environment 100, a data provider 1310 and a data recipient 1320 can be provided. While shown as being within the cloud computing, cloud infrastructure, or data analytics environment, it is readily understood that the data recipient can be external to the environment 100, such as a client or user accessing the environment 100 from another location.

In accordance with an embodiment, at a data provider 1310, which can comprise the Delta Share provider 1311, there can be a number of data sources, such as Delta Lakes 1330, databases, such as autonomous database 1331, and data lakes 1322. A data share server (for example, a Delta Share server) 1350 can additionally be provided, for example, in connection with the Delta Share provider 1311.

In accordance with an embodiment, a data recipient 1320 can comprise Delta Share consumers 1321. The data recipient can comprise, for example, a client 1322, such as an Oracle Analytics Cloud (OAC) client, databases 1323 (such as autonomous databases), a query service 1324, various clients, such as Spark 1325, Pandas 1326, or Power BI 1327, and a data sharing client (for example, a Delta Sharing client) 1328.

In accordance with an embodiment, from a client, such as a cloud client, such as OAC 1322, a data recipient can request access to certain tables from the data provider. This request can be directed to the Delta Share sever 1350.

In accordance with an embodiment, assuming that the requested tables are of a format supported by the Delta Share service, such as Delta files or Parquet files 1312, the data share server can provide, to the data recipient, one or more addresses, such as URLs, which can be utilized to initiate data sharing. These URLs can comprise pre-authorized request URLs. Such pre-authenticated request URLs can provide secure and time-limited access to the requested shared data or objects without requiring the data share recipient to provide credentials.

In accordance with an embodiment, the data recipient, utilizing the addresses, can then obtain access to the requested data to be shared, e.g., via a data sharing client 1328. The requested data can comprise, for example, the Delta or Parquet files stored at OCI, S3, GCP, ADLs, etc. Such access can additionally comprise pre-authenticated requests.

In accordance with an embodiment, it is noted that while shown in an embodiment where the data recipient initiates the transfer of shared files via a request, it is to be readily understood that a data provider can likewise initiate a transfer of shared files to a data recipient without the trigger of receiving a request. Such sharing could be triggered upon receiving an instruction from an authorized user of the data provider (e.g., a retailer providing sales data to an accounting firm), on a scheduled/routine basis (e.g., pushing inventory data at the end of every day).

In accordance with an embodiment, the described approach enables users to securely share data in all data formats with a Delta Sharing protocol. The systems and methods make protocols such as Delta-Sharing a truly data share solution friendly to all data formats:

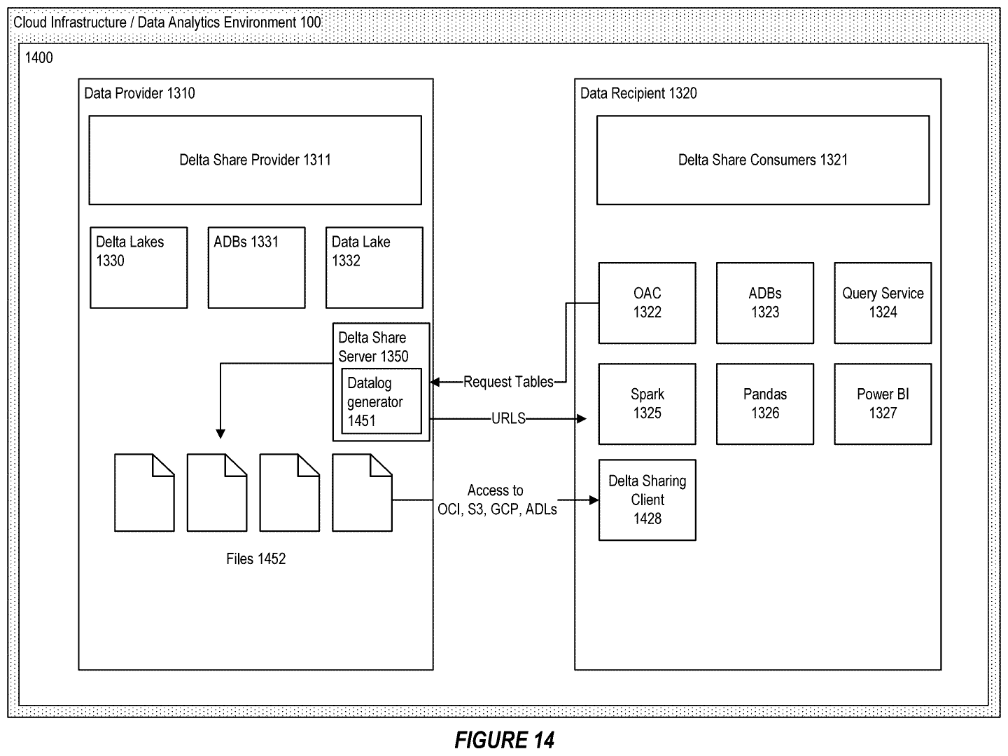

FIG. 14 illustrates a system for use with a data analytics environment to provide an open data share for data formats with Delta Sharing, in accordance with an embodiment.

In accordance with an embodiment, at a cloud computing, cloud infrastructure or data analytics environment 100, a data provider 1310 and a data recipient 1320 can be provided. While shown as being within the cloud computing, cloud infrastructure, or data analytics environment, it is readily understood that the data recipient can be external to the environment 100, such as a client or user accessing the environment 100 from another location.

In accordance with an embodiment, at a data provider 1310, which can comprise the Delta Share provider 1311, there can be a number of data sources, such as Delta Lakes 1330, databases, such as autonomous database 1331, and data lakes 1322. A data share server 1350 can additionally be provided, for example, in connection with the Delta Share provider 1311. The data share server can comprise a datalog generator 1451.

In accordance with an embodiment, a data recipient 1320 can comprise Delta Share consumers 1321. The data recipient can comprise, for example, a client 1322, such as an OAC client, databases 1323 (such as autonomous databases), a query service 1324, various clients, such as Spark 1325, Pandas 1326, or Power BI 1327, and a data sharing client 1328.

In accordance with an embodiment, from a client, such as a cloud client, such as OAC 1322, a data recipient can request access to certain tables from the data provider. This request can be directed to the Delta Share sever 1350.

In accordance with an embodiment, in the situation where the requested tables are of a format not supported by the Delta Share service, such as Avro, ORC, or JSON files 1452, the data share server can generate a data log file which comprises metadata and/or a transactional log for the tables and data that is not natively supported by Delta Share. This data log file can comprise a snapshot, including metadata about the data (e.g., how many columns, how many partitions, a number of files, statistics about the table).

In accordance with an embodiment, this generated data log file can be embedded into the data requested to be shared as a hidden log file in a hidden folder so it will not be counted as part of the data file.

In accordance with an embodiment, the data share server can utilize a parser extension in order to generate the data log file. This parser extension can comprise, for example, a parser extension for SQL (e.g., Spark SQL) to provide/allow for the generation of metadata for the data tables (e.g., the requested data tables that are not natively supported by Delta Share) and add the generated data log file to the shared files.

In accordance with an embodiment, in order to, after generating the data log file, the data share server can provide, to the data recipient, one or more addresses, such as URLs, which can be utilized to initiate data sharing. These URLs can comprise pre-authorized request URLs. Such pre-authenticated request URLs can provide secure and time-limited access to the requested shared data or objects without requiring the data share recipient to provide credentials.

In accordance with an embodiment, the data recipient, utilizing the addresses, can then obtain access to the requested data to be shared, e.g., via a data sharing client 1428, where the data sharing client can, via the generated data log file, obtain access to the requested data. The requested data can comprise, for example, data files and data tables stored at OCI, S3, GCP, ADLs, etc., in formats other than Delta or Parquet. Such access can additionally comprise pre-authenticated requests.

In accordance with an embodiment, it is noted that while shown in an embodiment where the data recipient initiates the transfer of shared files via a request, it is to be readily understood that a data provider can likewise initiate a transfer of shared files to a data recipient without the trigger of receiving a request. Such sharing could be triggered upon receiving an instruction from an authorized user of the data provider (e.g., a retailer providing sales data to an accounting firm), on a scheduled/routine basis (e.g., pushing inventory data at the end of every day.

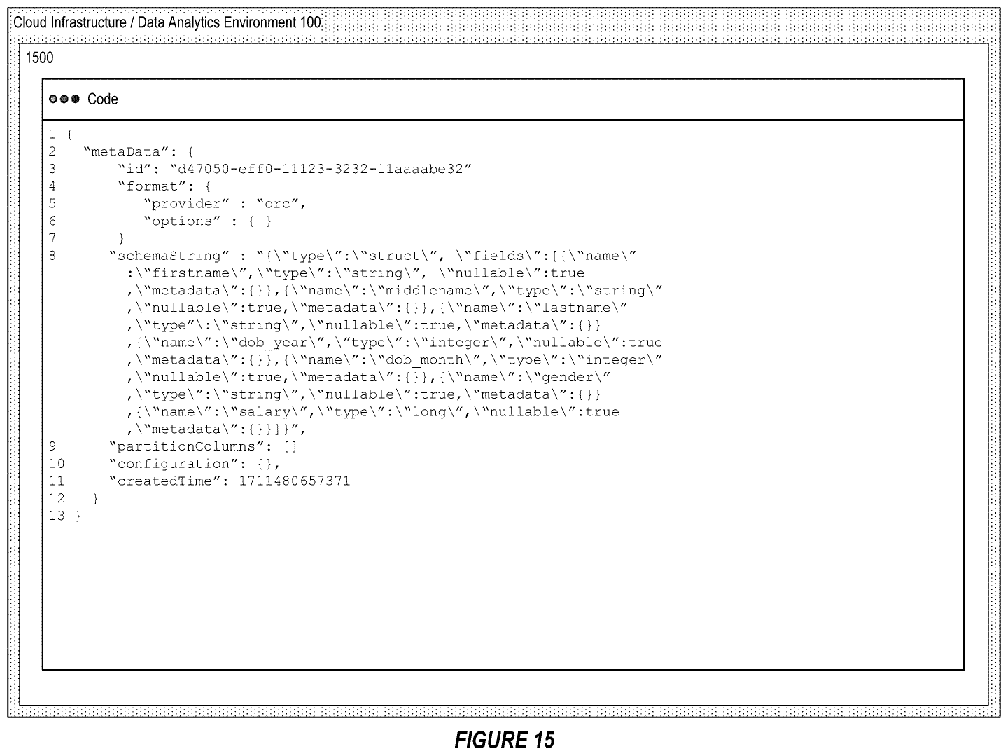

FIG. 15 illustrates an exemplary file format for use with a data analytics environment to provide an open data share for data formats with Delta Sharing, in accordance with an embodiment.

In accordance with an embodiment, FIG. 15 illustrates an exemplary file format that can be generated in association with a generated data log, as described above. The format 1500 illustrates a format for metadata of a data table. In the depicted embodiment, it is illustrated that the file format is “orc”. This can indicate that the data log generated for the particular file is natively an ORC format. The data log generated for this data table can then be utilized for Delta Share, despite the data table being a non-native format for Delta Share.

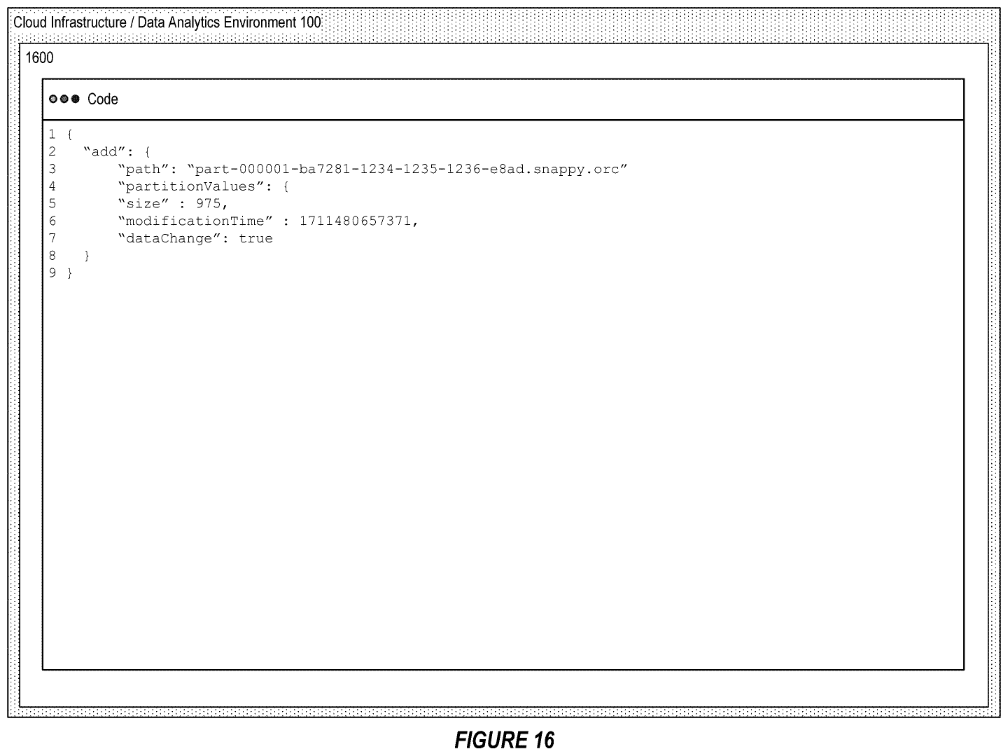

FIG. 16 illustrates an exemplary file format for use with a data analytics environment to provide an open data share for data formats with Delta Sharing, in accordance with an embodiment.

In accordance with an embodiment, FIG. 16 illustrates an exemplary file format that can be generated in association with a generated data log, as described above. The format 1600 illustrates a format for metadata of a table file.

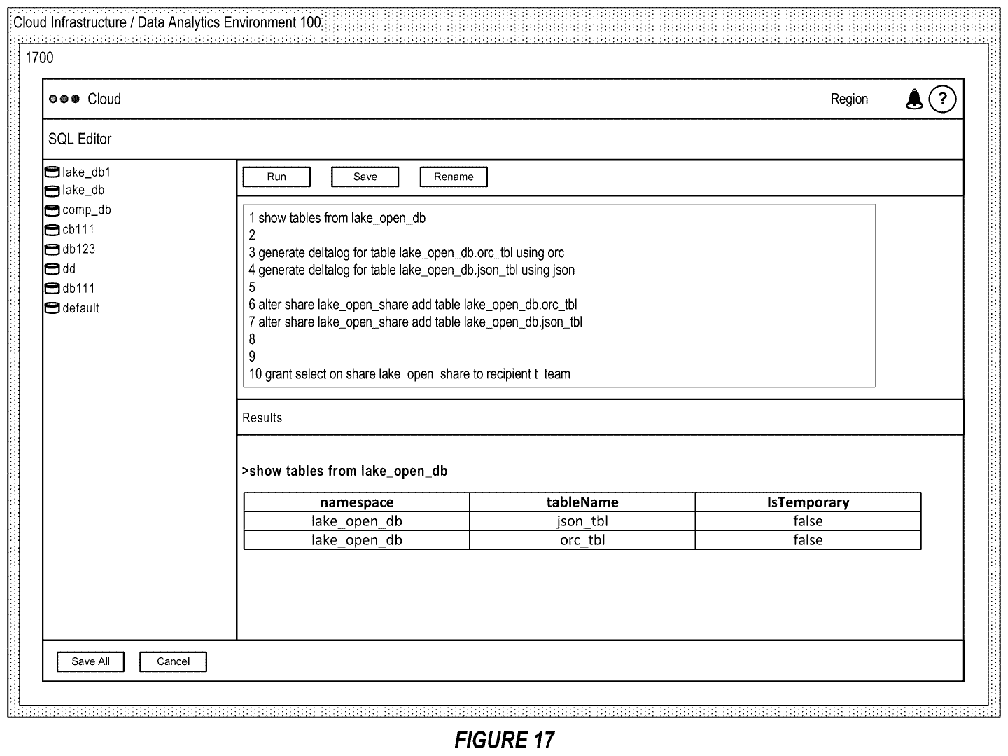

FIG. 17 illustrates a screenshot produced by a system for use with a data analytics environment to provide an open data share for data formats with Delta Sharing, in accordance with an embodiment.

In accordance with an embodiment, as shown in FIG. 17, within a cloud infrastructure environment 100, an editor 1700 can be provided. Show in the editor is a sample for creating a data log (e.g., deltalog) for use in the above-described embodiments. As shown, the target database from which data logs are created is “lake_open_db”. The code then specifies to create a deltalog for table “lake_open_db” for both formats “orc” and “json”. These data logs are then put in the share files (“lake_open_share”) via an “alter share” command which adds both deltalogs (one each for ORC and JSON formats). As described above, these deltalogs are hidden files within the share files.

In accordance with an embodiment, access to the “lake_open_share” to an indicated recipient, t_team.

In accordance with an embodiment, as shown at the bottom, both json_tbl and orc_tbl were added to the namespace lake_open_db.

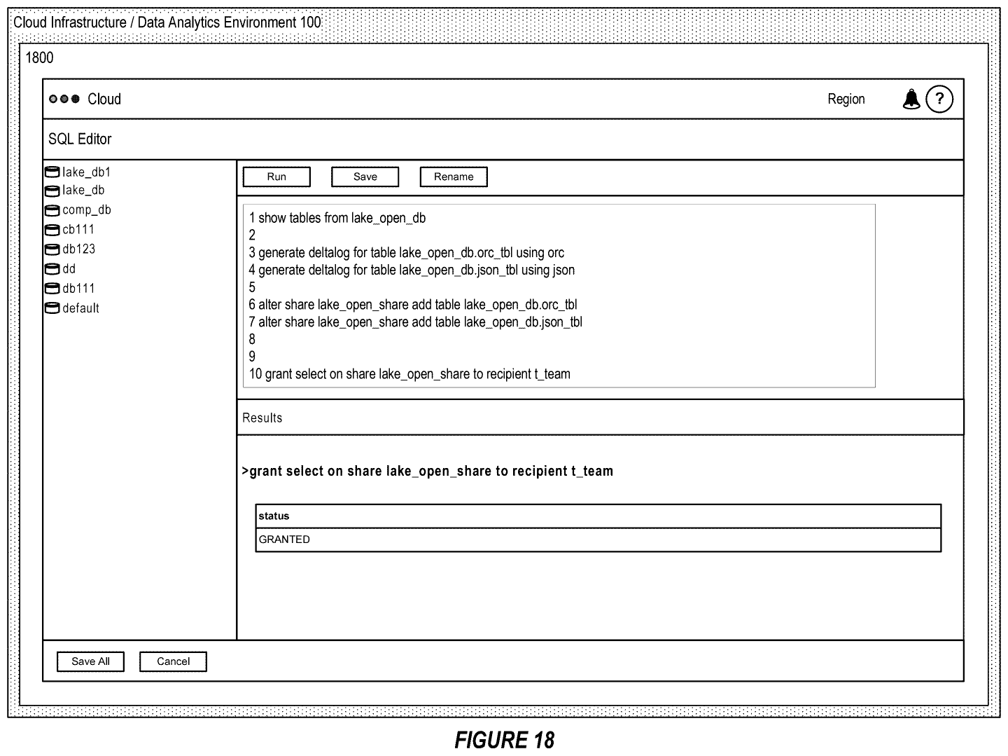

FIG. 18 illustrates a screenshot produced by a system for use with a data analytics environment to provide an open data share for data formats with Delta Sharing, in accordance with an embodiment.

In accordance with an embodiment, as shown in FIG. 18, within a cloud infrastructure environment 100, an editor 1800 can be provided. Shown in the editor is a sample for creating a data log (e.g., deltalog) for use in the above-described embodiments. As shown, the target database from which data logs are created is “lake_open_db”. The code then specifies to create a deltalog for table “lake_open_db” for both formats “orc” and “json”. These deltalogs are then put in the share files (“lake_open_share”) via an “alter share” command which adds both deltalogs (one each for ORC and JSON formats). As described above, these deltalogs are hidden files within the share files.

In accordance with an embodiment, access to the “lake_open_share” to an indicated recipient, t_team.

In accordance with an embodiment, as shown at the bottom, it is shown that the shared status for lake_open_share to t_team is granted.

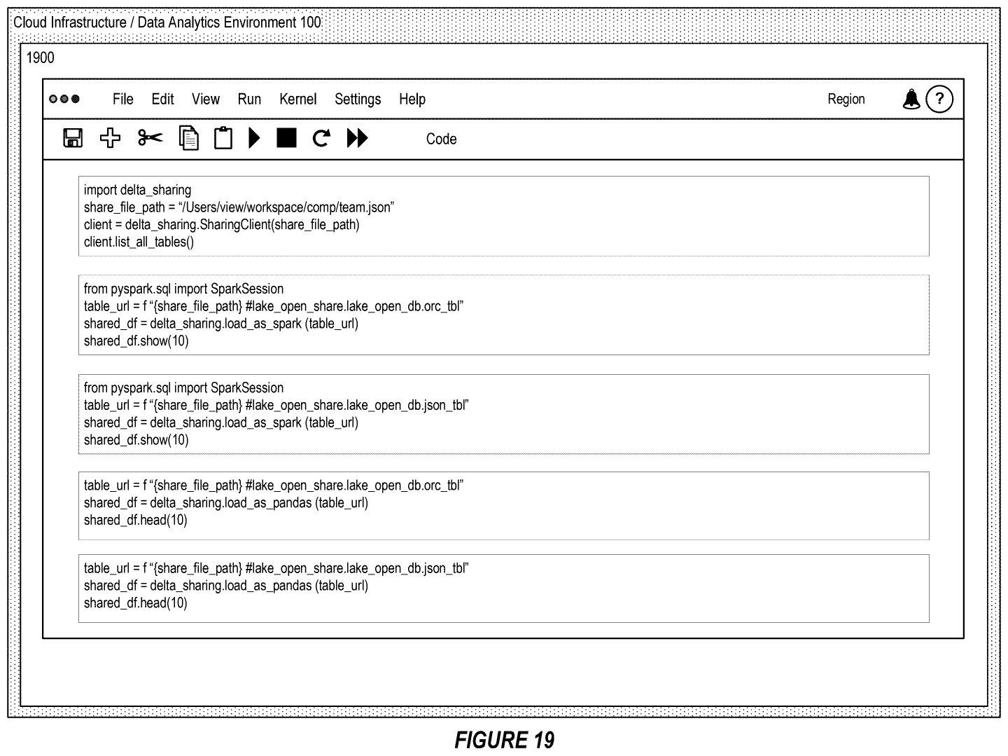

FIG. 19 illustrates a screenshot produced by a system for use with a data analytics environment to provide an open data share for data formats with Delta Sharing, in accordance with an embodiment.

In accordance with an embodiment, FIG. 19 illustrates a runtime from a data sharing client 1900. As shown in FIG. 19, at the first box, the client imports the share_file_path together with providing the client. At the next two boxes, the both tables for ORC and JSON format are pulled/shared to the client utilizing the data logs (e.g., deltalogs) which were created in order to utilize Delta Sharing which is agnostic to the data format of the tables. In these two boxes, the data is pulled in associated with Spark.

In accordance with an embodiment, FIG. 19 illustrates a runtime from a data sharing client 1900. As shown in FIG. 19, at the final two boxes, the both tables for ORC and JSON format are pulled/shared to the client utilizing the data logs (e.g., deltalogs) which were created in order to utilize Delta Sharing which is agnostic to the data format of the tables. In these two boxes, the data is pulled in associated with Panda.

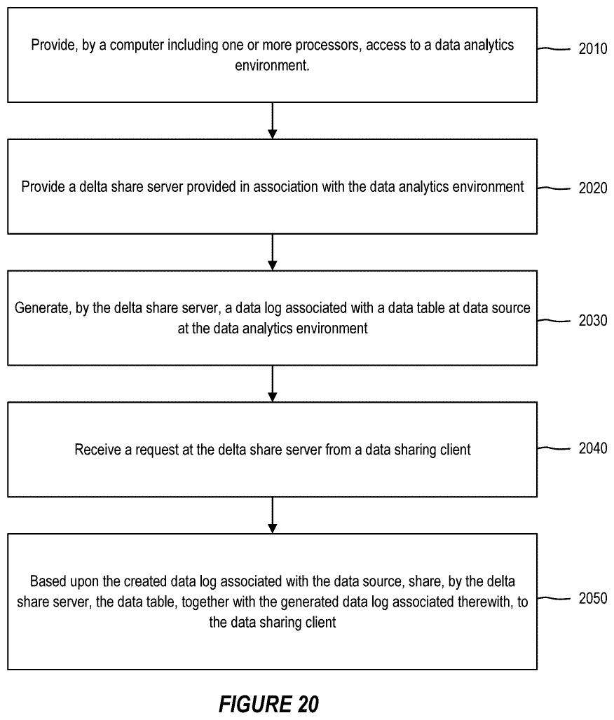

FIG. 20 is a flowchart of a method for use with a data analytics environment to provide an open data share for data formats with Delta Sharing, in accordance with an embodiment.

At step 2010, in accordance with an embodiment, the method can provide, by a computer including one or more processors, access to a data analytics environment.

At step 2020, in accordance with an embodiment, the method can provide a data share server provided in association with the data analytics environment.

At step 2030, in accordance with an embodiment, the method can generate, by the data share server, a data log associated with a data table at data source at the data analytics environment.

At step 2040, in accordance with an embodiment, the method can receive a request at the data share server from a data sharing client.

At step 2050, in accordance with an embodiment, the method can, based upon the created data log associated with the data source, share, by the data share server, the data table, together with the generated data log associated therewith, to the data sharing client.

In accordance with various embodiments, the systems and methods described herein can be implemented using one or more computer, computing device, machine, or microprocessor, including one or more processors, memory and/or computer readable storage media programmed according to the teachings of the present disclosure. Appropriate software coding can readily be prepared by skilled programmers based on the teachings of the present disclosure, as will be apparent to those skilled in the software art.

In some embodiments, the teachings herein can include a computer program product which is a non-transitory computer readable storage medium (media) having instructions stored thereon/in which can be used to program a computer to perform any of the processes of the present teachings. Examples of such storage mediums can include, but are not limited to, hard disk drives, hard disks, hard drives, fixed disks, ROMs, RAMs, EPROMs, EEPROMs, DRAMs, VRAMs, flash memory devices, or other types of storage media or devices suitable for non-transitory storage of instructions and/or data.

The foregoing description has been provided for the purposes of illustration and description. It is not intended to be exhaustive or to limit the scope of protection to the precise forms disclosed. Many modifications and variations will be apparent to the practitioner skilled in the art. For example, although several of the examples provided herein illustrate use with cloud environments such as Oracle Analytics Cloud; in accordance with various embodiments, the systems and methods described herein can be used with other types of enterprise software applications, cloud environments, cloud services, cloud computing, or other computing environments.

The embodiments were chosen and described in order to best explain the principles of the present teachings and their practical application, thereby enabling others skilled in the art to understand the various embodiments and with various modifications that are suited to the particular use contemplated. It is intended that the scope be defined by the following claims and their equivalents.

What is claimed is:

1. A system for use with a data analytics environment to provide an open data share for data formats, comprising:
a computer including one or more processors, that provides access to a data analytics environment; and
a data share server provided in association with the data analytics environment;
wherein the data share server generates a data log associated with a data table at data source at the data analytics environment;
wherein a request is received at the data share server from a data sharing client; and
wherein, based upon the created data log associated with the data source, the data share server shares the data table, together with the generated data log associated therewith, to the data sharing client.

2. The system of claim 1, wherein the data log is generated upon an indication that the data table comprises a data format other than one of Parquet and Delta.

3. The system of claim 2, wherein the generated data log associated with the data table comprises metadata associated with the data table.

4. The system of claim 3, wherein the generated data log associated with the data table is added to a shared location and is utilized in sharing the data table to the data sharing client.

5. The system of claim 4, wherein the data share server comprises a data share server.

6. The system of claim 5, wherein the generated data log is utilized in sharing data of the data table, the data comprising a format of at least one of Avro, ORC, or JSON.

7. The system of claim 6, wherein the data sharing client comprises a Delta Sharing client.

8. A method for use with a data analytics environment to provide an open data share for data formats, comprising:
providing, by a computer including one or more processors, access to a data analytics environment;
providing a data share server provided in association with the data analytics environment;
generating, by the data share server, a data log associated with a data table at data source at the data analytics environment;
receiving a request at the data share server from a data sharing client; and
based upon the created data log associated with the data source, sharing, by the data share server, the data table, together with the generated data log associated therewith, to the data sharing client.

9. The method of claim 8, wherein the data log is generated upon an indication that the data table comprises a data format other than one of Parquet and Delta.

10. The method of claim 9, wherein the generated data log associated with the data table comprises metadata associated with the data table.

11. The method of claim 10, wherein the generated data log associated with the data table is added to a shared location and is utilized in sharing the data table to the data sharing client.

12. The method of claim 11, wherein the data share server comprises a data share server.

13. The method of claim 12, wherein the generated data log is utilized in sharing data of the data table, the data comprising a format of at least one of Avro, ORC, or JSON.

14. The method of claim 13, wherein the data sharing client comprises a Delta Sharing client.

15. A non-transitory computer readable storage medium having instructions thereon for use with a data analytics environment to provide an open data share for data formats, which when read and executed cause a computer to perform steps comprising:
providing, by the computer, the computer including one or more processors, access to a data analytics environment;
providing a data share server provided in association with the data analytics environment;
generating, by the data share server, a data log associated with a data table at data source at the data analytics environment;
receiving a request at the data share server from a data sharing client; and
based upon the created data log associated with the data source, sharing, by the data share server, the data table, together with the generated data log associated therewith, to the data sharing client.

16. The non-transitory computer readable storage medium of claim 15, wherein the data log is generated upon an indication that the data table comprises a data format other than one of Parquet and Delta.

17. The non-transitory computer readable storage medium of claim 16, wherein the generated data log associated with the data table comprises metadata associated with the data table.

18. The non-transitory computer readable storage medium of claim 17, wherein the generated data log associated with the data table is added to a shared location and is utilized in sharing the data table to the data sharing client.

19. The non-transitory computer readable storage medium of claim 18, wherein the data share server comprises a data share server.

20. The non-transitory computer readable storage medium of claim 19, wherein the generated data log is utilized in sharing data of the data table, the data comprising a format of at least one of Avro, ORC, or JSON;
wherein the data sharing client comprises a Delta Sharing client.
